(19) United States
(12) Patent Application Publication
(10) Pub. No.: US 2026/0094020 A1
(43) Pub. Date: Apr. 2, 2026

(54) GENERATION METHOD AND INFORMATION PROCESSING APPARATUS

(71) Applicant: Fujitsu Limited, Kawasaki-shi (JP)

(72) Inventors: Akihiro WADA, Kawasaki (JP); Tatsuya KIKUZUKI, Kawasaki (JP); Masatoshi OGAWA, Zama (JP); Teruhisa NINOMIYA, Yokohama (JP)

(73) Assignee: Fujitsu Limited, Kawasaki-shi (JP)

(21) Appl. No.: 19/336,421

(22) Filed: Sep. 22, 2025

(30) Foreign Application Priority Data
Sep. 27, 2024 (JP) 2024-168158

(51) Int. Cl. G06N 5/022

(52) U.S. Cl. CPC G06N 5/022

(57) ABSTRACT

A processing unit acquires a combination of a first entity included in a first knowledge graph and a second entity included in a second knowledge graph. The processing unit inputs the first entity and the second entity to a machine learning model and instructs the machine learning model to decrease the similarity between the first entity and the second entity if the relationship between the first entity and the second entity is a predetermined relationship. The processing unit acquires the similarity between the first entity and the second entity output by the machine learning model. The processing unit generates a third knowledge graph by merging the first knowledge graph and the second knowledge graph, treating the first entity and the second entity as identical entities if their similarity is greater than a threshold.

### CROSS-REFERENCE TO RELATED APPLICATION

This application is based upon and claims the benefit of priority of the prior Japanese Patent Application No. 2024-168158, filed on Sep. 27, 2024, the entire contents of which are incorporated herein by reference.

### FIELD

The embodiments discussed herein relate to a generation method and an information processing apparatus.

### BACKGROUND

In computer systems, information referred to as a knowledge graph may be used to represent certain knowledge. A knowledge graph is data having a graph structure that includes a plurality of nodes corresponding to a plurality of entities, and represents relationships between the entities via edges connecting the nodes. The entities represent real-world objects, events, or others.

For example, there has been proposed a knowledge graph generation apparatus that generates graph data of a knowledge graph in which each word included in a plurality of natural language sentences is represented as a node and the relationships between the words of each word pair in the natural language sentences are represented as edges. The knowledge graph generation apparatus calculates a cosine similarity for each word pair in each natural language sentence pair, and connects similar nodes in each natural language sentence pair, based on the cosine similarities of the respective word pairs of the natural language sentence pair.

In addition, there has been proposed a processor system that evaluates a semantic similarity between a first knowledge item included in a first knowledge graph and a second knowledge item included in a second knowledge graph, and generates, when the similarity satisfies a predetermined condition, an integrated graph in which the first knowledge graph and the second knowledge graph are integrated. The processor system calculates the similarity between knowledge items, using a correspondence word dictionary in which semantic correspondence words related to notations of the knowledge items (for example, a failure factor name) are registered.

In addition, there has been proposed a system that indirectly links a first knowledge graph and a second knowledge graph via a graph called a meta-layer knowledge graph.

In addition, there has been proposed a knowledge graph fusion device that identifies identical or similar entities from a plurality of knowledge graphs and fuses the plurality of knowledge graphs. The knowledge graph fusion device evaluates the similarity between two entities using a cosine similarity.

Furthermore, there has been proposed a system that determines the similarity among subgraphs of each knowledge graph, based on the structure of the conceptual objects corresponding to nodes and edges connecting the conceptual objects in that knowledge graph. See, for example, the following literatures.
Japanese Patent No. 7486678
Japanese Laid-open Patent Publication No. 2024-5871
International Publication Pamphlet No. WO 2020/182434
U.S. Patent Application Publication No. 2023/0206127
U.S. Patent Application Publication No. 2021/0286834

### SUMMARY

In one aspect, there is provided a generation method including: acquiring, by a processor, from a first knowledge graph and a second knowledge graph, a combination of a first entity included in the first knowledge graph and a second entity included in the second knowledge graph, each of the first knowledge graph and the second knowledge graph representing a causal relationship between a plurality of entities; inputting, by the processor, the first entity and the second entity to a machine learning model and instructing the machine learning model to decrease a similarity between the first entity and the second entity upon determining that a relationship between the first entity and the second entity is a predetermined relationship, the machine learning model being capable of outputting a similarity between two entities in response to an input of the two entities; acquiring, by the processor, the similarity between the first entity and the second entity, the similarity being output by the machine learning model; and generating, by the processor, a third knowledge graph by merging the first knowledge graph and the second knowledge graph, treating the first entity and the second entity whose similarity is greater than a threshold as identical entities.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing an information processing apparatus according to a first embodiment;

FIG. 2 illustrates an example of hardware of an information processing apparatus according to a second embodiment;

FIG. 3 illustrates examples of a knowledge graph;

FIG. 4 illustrates an example of an integrated knowledge graph;

FIG. 5 illustrates an example of functions of the information processing apparatus;

FIG. 6 illustrates an example of a prompt;

FIG. 7 is a flowchart illustrating an example of generating an integrated knowledge graph;

FIG. 8 is a flowchart illustrating an example of the identical entity determination process;

FIGS. 9A and 9B illustrate comparative examples of a similarity estimation method;

FIG. 10 illustrates an example of similarity evaluation results obtained with some similarity estimation methods;

FIG. 11 illustrates examples of integration of knowledge graphs;

FIGS. 12A and 12B are diagrams for describing ToT;

FIG. 13 is a diagram for describing ICL;

FIG. 14 is a flowchart illustrating a modification of the identical entity determination process;

FIGS. 15A and 15B illustrate examples of prompts;

FIG. 16 illustrates an example (continuation) of a prompt;

FIG. 17 illustrates an example of functions of an information processing apparatus according to a third embodiment;

FIG. 18 illustrates an example of filtering based on cosine similarity;

FIG. 19 is a flowchart illustrating an example of the identical entity determination process;

FIG. 20 illustrates an example of functions of an information processing apparatus according to a fourth embodiment;

FIG. 21 illustrates an example of selecting a combination of entities to be fused;

FIG. 22 is a flowchart illustrating an example of an identical entity merging process;

FIG. 23 illustrates an example of functions of an information processing apparatus according to a fifth embodiment;

FIG. 24 is a diagram for describing how to set thresholds; and

FIG. 25 illustrates a use case of an integrated knowledge graph.

### DESCRIPTION OF EMBODIMENTS

It is considered that sentences included in a document are taken as entities, and causal relationships between events or things represented by the sentences in the document are represented by a knowledge graph. By integrating knowledge graphs corresponding to documents, it is possible to enrich the knowledge represented by the knowledge graphs.

This case has a problem in how to evaluate the similarity between two entities included in the knowledge graphs. For example, an existing method using cosine similarity exhibits a low accuracy in similarity estimation between sentences. For example, in the case where one entity represents a first event and another entity represents a second event caused by the first event, the existing method may erroneously determine that these entities are identical. If this happens, in the integration of the knowledge graphs, these entities may be aggregated into one entity. This causes a possibility that the information on the original knowledge graphs is not appropriately reflected in the integrated knowledge graph.

Hereinafter, embodiments will be described with reference to the drawings.

### First Embodiment

A first embodiment will be described.

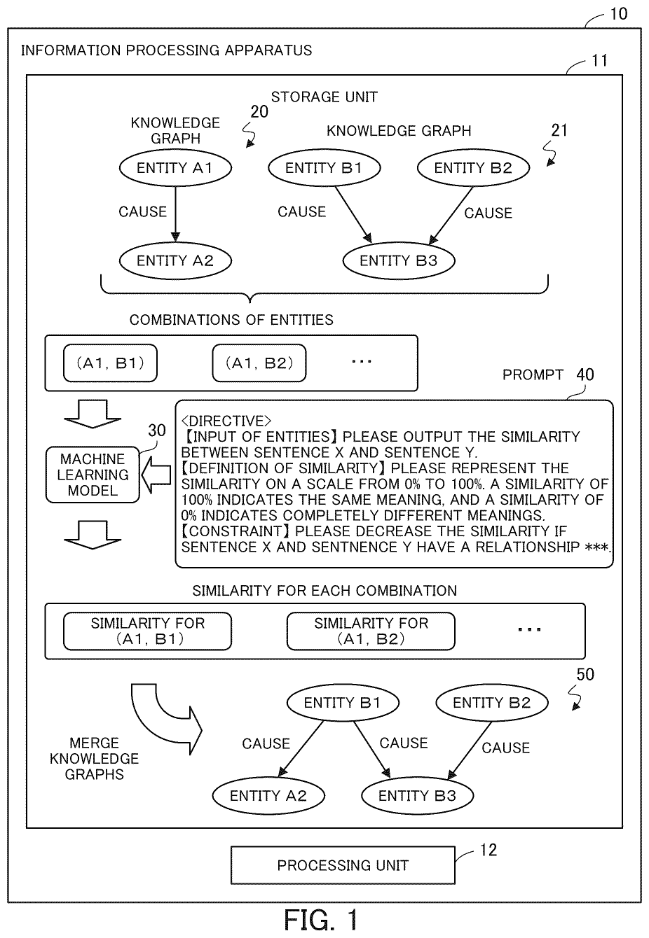

FIG. 1 is a diagram for describing an information processing apparatus according to the first embodiment.

The information processing apparatus 10 performs a process of integrating a plurality of knowledge graphs. The information processing apparatus 10 includes a storage unit 11 and a processing unit 12.

The storage unit 11 may be a volatile semiconductor memory such as a random access memory (RAM) or a non-volatile storage such as a hard disk drive (HDD) or a flash memory. The storage unit 11 stores information representing a plurality of knowledge graphs. Each of the plurality of knowledge graphs includes a plurality of entities. Each of the plurality of entities is a sentence extracted from a document or the like. Note that some of the plurality of entities may be words. A knowledge graph represents the causal relationships between entities in a document or the like, from which the entities are extracted. In the knowledge graph, the entities are represented by nodes. The causal relationship between two entities is represented by an edge connecting two nodes corresponding to the two entities.

The processing unit 12 is, for example, a processor such as a central processing unit (CPU), a graphics processing unit (GPU), or a digital signal processor (DSP). Alternatively, the processing unit 12 may include a special-purpose electronic circuit such as an application specific integrated circuit (ASIC) or a field programmable gate array (FPGA). The processor executes a program stored in a memory (or the storage unit 11) such as a RAM. A set of a plurality of processors may be referred to as a “multiprocessor” or simply as a “processor”.

The processing unit 12 obtains a first knowledge graph and a second knowledge graph on the basis of information representing a plurality of knowledge graphs stored in the storage unit 11. For example, the processing unit 12 obtains knowledge graphs 20 and 21. The knowledge graphs 20 and 21 are examples of the first and second knowledge graphs.

The knowledge graph 20 includes entities A1 and A2, and represents a causal relationship between the entities, in which a cause of an event represented by the entity A1 is an event represented by the entity A2. The knowledge graph 21 includes entities B1, B2, and B3, and represents a causal relationship between entities, in which a cause of an event represented by each of the entities B1 and B2 is an event represented by the entity B3. The term “event” may be interpreted as a term including “thing” and “phenomenon”.

The processing unit 12 acquires a combination of a first entity included in the first knowledge graph and a second entity included in the second knowledge graph. For example, the processing unit 12 acquires all combinations of a first entity belonging to the knowledge graph 20 and a second entity belonging to the knowledge graph 21, including (A1, B1), (A1, B2), (A1, B3), (A2, B1), (A2, B2), and (A2, B3).

The processing unit 12 uses a machine learning model 30 to estimate the similarity between two entities. The machine learning model 30 is able to output the similarity between two entities in response to an input of the two entities. The similarity between two entities refers to a semantic similarity between two sentences indicated by the two entities. A higher similarity between two entities indicates a higher degree of similarity between them. For example, the machine learning model 30 may be a large language model (LLM). Examples of LLMs that are usable as the machine learning model 30 include Llama 2, Llama 3, Command r+, GPT-4 (registered trademark), and GEMINI (registered trademark). The machine learning model 30 may be held in the storage unit 11 or may be provided by another information processing apparatus that communicates with the information processing apparatus 10 via a network.

The processing unit 12 inputs a first entity and a second entity to the machine learning model 30 and instructs the machine learning model 30 to decrease the similarity between the first entity and the second entity if the relationship between the first entity and the second entity is a predetermined relationship.

Examples of the predetermined relationship here include a cause-effect relationship, a simultaneity relationship, a subject-predicate relationship, and others. The cause-effect relationship is, for example, a relationship in which an event represented by a second entity occurs due to an event represented by a first entity. In this case, the first entity serves as a cause, and the second entity serves as an effect corresponding to the cause. The simultaneity relationship is a relationship in which an event represented by a second entity occurs simultaneously with the occurrence of an event represented by a first entity. The subject-predicate relationship is a relationship in which an event represented by a first entity serves as a subject (or a subject phrase) and an event represented by a second entity serves as a predicate (or a predicate phrase) in a given sentence.

A prompt 40 is an example of a directive that is input from the processing unit 12 to the machine learning model 30. In one example, the prompt 40 includes a statement, “Please output the similarity between sentence X and sentence Y.”, as an input of entities, and an instruction to output their similarity. The sentences X and Y correspond to two entities that are input to the machine learning model 30. In addition, the prompt 40 includes a statement, “Please represent the similarity on a scale from 0% to 100%. A similarity of 100% indicates the same meaning, and a similarity of 0% indicates completely different meanings.”, as a definition of the similarity.

The prompt 40 also includes a statement, “Please decrease the similarity if sentence X and sentence Y have a relationship ***.”, as a constraint. For example, the processing unit 12 describes at least one of a “cause-effect relationship”, a “simultaneity relationship”, a “subject-predicate relationship”, and others, as the “relationship ***”.

For example, the processing unit 12 inputs a combination of the entities A1 and B1, the definition of the similarity, and the constraint to the machine learning model 30 using the prompt 40. For example, in the case where the machine learning model 30 is provided by another information processing apparatus, the processing unit 12 is able to input the prompt 40 to the machine learning model 30 by transmitting information on the prompt 40 to the other information processing apparatus via a network.

The machine learning model 30 determines whether the entities A1 and B1 have the relationship specified as the constraint. For example, the processing unit 12 may include, in addition to the specification of a relationship such as “a cause-effect relationship”, “a simultaneity relationship”, or “a subject-predicate relationship” in the prompt 40, an example of two entities having the specified relationship in the prompt 40. By doing so, the processing unit 12 enables the machine learning model 30 to determine whether the relationship is satisfied, with higher accuracy.

Then, the processing unit 12 acquires the similarity between the first entity and the second entity, which is output by the machine learning model 30. For example, the processing unit 12 performs the above-described process on each combination of two entities (A1, B1), (A1, B2), . . . to thereby obtain the similarity for each combination, including the similarity between the entities A1 and B1, the similarity between the entities A1 and B2,

The processing unit 12 compares the similarity with a threshold, for each combination of the first entity and the second entity. The processing unit 12 generates a third knowledge graph by merging the first knowledge graph and the second knowledge graph, treating the first entity and the second entity as identical entities if their similarity is greater than a threshold. The processing unit 12 does not treat the first entity and the second entity as identical entities if their similarity is less than or equal to the threshold. Here, in the case where the similarity between the first entity and the second entity is greater than the threshold, the first entity and the second entity may be considered semantically equivalent entities that are shared by the first knowledge graph and the second knowledge graph.

A knowledge graph 50 is an example of a knowledge graph obtained by merging the knowledge graphs 20 and 21. For example, the processing unit 12 detects that the similarity between the entities A1 and B1 is greater than the threshold. Then, the processing unit 12 generates the knowledge graph 50 by merging the knowledge graphs 20 and 21, treating the entity A1 in the knowledge graph 20 and the entity B1 in the knowledge graph 21 as identical entities. More specifically, the processing unit 12 generates the knowledge graph 50 by integrating the entity A1 of the knowledge graph 20 and the entity B1 of the knowledge graph 21 into one entity. For example, the processing unit 12 aggregates the entity A1 into the entity B1 and leaves the entity B1. In the knowledge graph 20, the entity A1 has a causal relationship with the entity A2. Therefore, the knowledge graph 50 represents that the entity B1, instead of the entity A1, has a causal relationship with the entity A2.

Information on the knowledge graph 50 is held in the storage unit 11. For example, the knowledge graph 50 indicates that the cause of the event represented by the entity B1 is the event represented by either the entity A2 or the entity B3, and the cause of the event represented by the entity B2 is the event represented by the entity B3.

The process of generating the third knowledge graph by the processing unit 12 is also considered, for example, as a process of generating the third knowledge graph in which the first knowledge graph and the second knowledge graph are merged by fusing one entity of the first entity and the second entity whose similarity is greater than the threshold, into the other entity.

As described above, the information processing apparatus 10 obtains, from the first knowledge graph and the second knowledge graph, combinations of a first entity included in the first knowledge graph and a second entity included in the second knowledge graph. The information processing apparatus 10 inputs a first entity and a second entity to the machine learning model that is able to output a similarity between two entities in response to inputs of the two entities. In addition, the information processing apparatus 10 instructs the machine learning model to decrease the similarity between the first entity and the second entity if the relationship between the first entity and the second entity is a predetermined relationship. The information processing apparatus 10 acquires the similarity between the first entity and the second entity output by the machine learning model. The information processing apparatus 10 then generates a third knowledge graph by merging the first knowledge graph and the second knowledge graph, treating the first entity and the second entity as identical entities if their similarity is greater than a threshold.

Accordingly, the information processing apparatus 10 is able to improve the accuracy of the similarity estimation between two entities. Specifically, the information processing apparatus 10 is able to reduce the likelihood that the first entity and the second entity are determined to be identical entities if the first entity and the second entity have a predetermined relationship such as a cause-effect relationship, a simultaneity relationship, a subject-predicate relationship or another. Therefore, in the case where the first entity and the second entity have such a predetermined relationship, the information processing apparatus 10 is able to reduce the likelihood that these entities are aggregated into one entity in the integrated knowledge graph. That is, the information processing apparatus 10 is able to suppress unneeded aggregation of entities in merging knowledge graphs and appropriately reflect information contained in each knowledge graph before the merging in the merged knowledge graph.

Note that the processing unit 12 may further merge another knowledge graph into the knowledge graph 50 using the technique exemplified in the first example embodiment. By sequentially repeating the margining for each knowledge graph, the processing unit 12 is able to generate a knowledge graph in which the plurality of knowledge graphs are integrated. As a result of the improvement in the accuracy of the similarity estimation between two entities, the information processing apparatus 10 is able to appropriately integrate the knowledge graphs.

The integrated knowledge graph is usable, for example, as training data for a machine learning model such as an LLM in a question answering system that generates answers to user-input questions expressed in natural language sentences. For example, this enables the question answering system to output detailed answers or a plurality of answer patterns based on knowledge obtained by integrating the content described in a plurality of documents.

### Second Embodiment

Next, a second embodiment will be described.

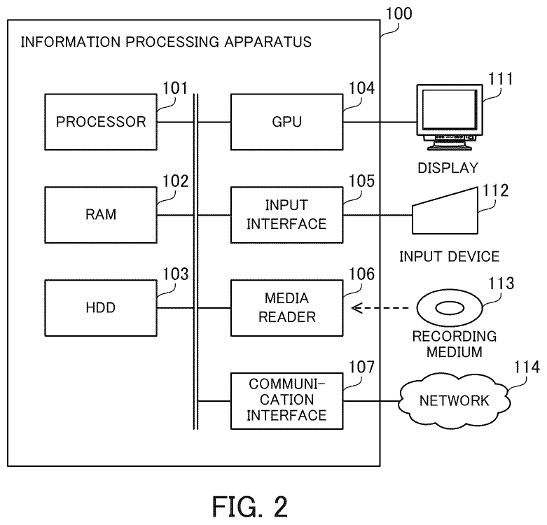

FIG. 2 illustrates an example of hardware of an information processing apparatus according to the second embodiment.

The information processing apparatus 100 performs a process of integrating a plurality of knowledge graphs. Each knowledge graph is data having a graph structure that includes a plurality of nodes corresponding to a plurality of entities, and represents relationships between the entities via edges connecting the nodes.

The information processing apparatus 100 includes a processor 101, a RAM 102, an HDD 103, a GPU 104, an input interface 105, a media reader 106, and a communication interface 107. These units included in the information processing apparatus 100 are connected to a bus inside the information processing apparatus 100. The processor 101 corresponds to the processing unit 12 of the first embodiment. The RAM 102 or the HDD 103 corresponds to the storage unit 11 of the first embodiment. The information processing apparatus 100 may be a computer.

The processor 101 is an arithmetic device that executes program instructions. The processor 101 is, for example, a CPU. The processor 101 loads at least a part of a program and data stored in the HDD 103 into the RAM 102 and executes the program. The processor 101 may include a plurality of processor cores. The information processing apparatus 100 may include a plurality of processors. A processor that performs a certain process among a plurality of processes performed by the information processing apparatus 100 may be different from a processor that performs a process different from the certain process among the plurality of processes. A set of a plurality of processors may be referred to as a “multiprocessor” or simply as a “processor”. The processor may be referred to as “processor circuitry”.

The RAM 102 is a volatile semiconductor memory that temporarily stores programs to be executed by the processor 101 and data to be used by the processor 101 for computation. The information processing apparatus 100 may include a memory of a type other than RAM, or may include a plurality of memories.

The HDD 103 is a non-volatile storage device that stores software programs such as an operating system (OS), middleware, and application software, and data. The information processing apparatus 100 may include another type of storage device such as a flash memory or a solid state drive (SSD), or may include a plurality of non-volatile storage devices.

The GPU 104 outputs images to a display 111 connected to the information processing apparatus 100 in accordance with instructions from the processor 101. The display 111 may be any type of display such as a cathode ray tube (CRT) display, a liquid crystal display (LCD), a plasma display, or an organic electro-luminescence (OEL) display.

The input interface 105 acquires input signals from an input device 112 connected to the information processing apparatus 100 and outputs the input signals to the processor 101. As the input device 112, a pointing device such as a mouse, a touch panel, a touch pad, or a trackball, a keyboard, a remote controller, a button switch, or the like may be used. A plurality of types of input devices may be connected to the information processing apparatus 100.

The media reader 106 is a reading device that reads programs and data recorded on a recording medium 113. As the recording medium 113, for example, a magnetic disk, an optical disc, a magneto-optical (MO) disk, a semiconductor memory, or the like may be used. Magnetic disks include a flexible disk (FD) and an HDD. Optical discs include a compact disc (CD) and a digital versatile disc (DVD).

For example, the media reader 106 copies a program or data read from the recording medium 113 to another recording medium such as the RAM 102 or the HDD 103. The read program is executed by, for example, the processor 101. The recording medium 113 may be a portable recording medium, and may be used to distribute programs and data. The recording medium 113 and the HDD 103 may be referred to as computer-readable storage media.

The communication interface 107 is connected to a network 114 and communicates with other information processing apparatuses via the network 114. The communication interface 107 may be a wired communication interface connected to a wired communication device such as a switch or a router, or may be a wireless communication interface connected to a wireless communication device such as a base station or an access point.

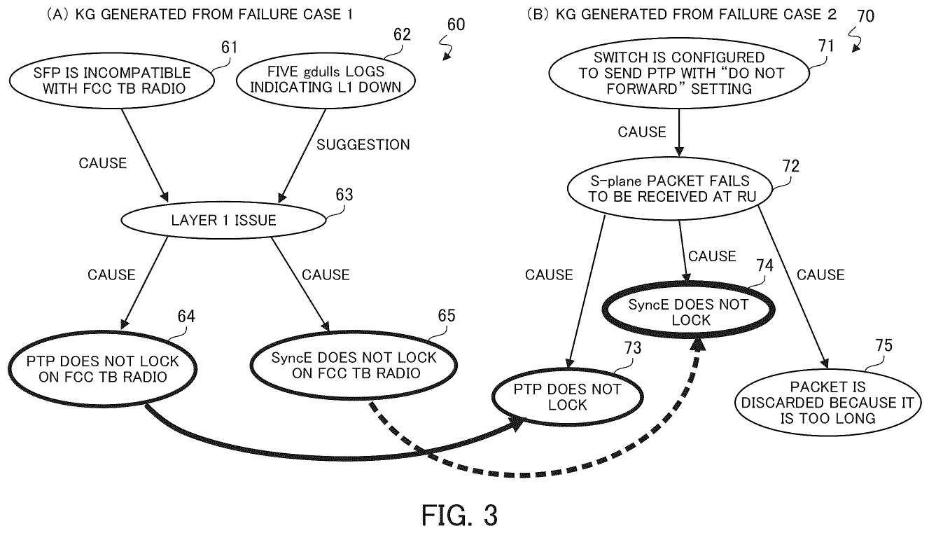

FIG. 3 illustrates examples of a knowledge graph.

For example, a knowledge graph is generated from a document about a failure case in a computer system. Note that the knowledge graph may be generated from a document related to events other than a failure in the computer system. Hereinafter, the knowledge graph may be abbreviated as KG.

(A) of FIG. 3 illustrates a KG 60 generated from a failure case 1. (B) of FIG. 3 illustrates a KG 70 generated from a failure case 2. In the example of FIG. 3, entities are obtained by dividing sentences describing a failure case, which include a failure content and its causes, into sentences each describing one piece of content. Note that some entities in knowledge graphs may be words.

The KG 60 includes entities 61, 62, 63, 64, and 65. The KG 60 has nodes corresponding respectively to the entities 61 to 65, and represents causal relationships, such as cause or suggestion, between the entities 61 to 65 by directed edges connecting the nodes.

The KG 70 includes entities 71, 72, 73, 74, and 75. The KG 70 has nodes corresponding respectively to the entities 71 to 75, and represents causal relationships, such as cause or suggestion, between the entities 71 to 75 by directed edges connecting the nodes.

The information processing apparatus 100 is able to merge the KGs 60 and 70 by aggregating, among pairs of an entity of the KG 60 and an entity of the KG 70, paired entities representing the same event into one entity. A KG generated by merging a plurality of KGs is referred to as an integrated KG.

In the example of the KGs 60 and 70, the entities 64 and 73 represent the same event. The entities 64 and 73 are semantically equivalent. The entities 65 and 74 represent the same event. That is, the entities 65 and 74 are semantically equivalent.

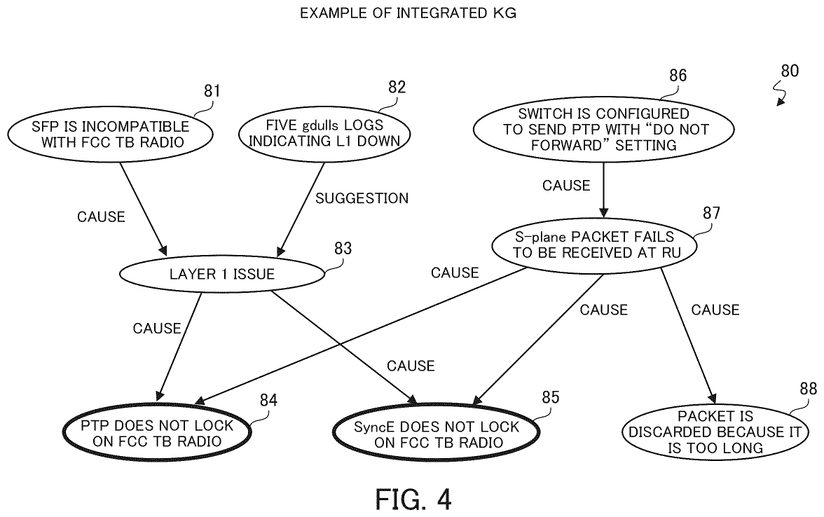

FIG. 4 illustrates an example of an integrated knowledge graph.

An integrated KG 80 is an example of a KG generated by merging the KGs 60 and 70. The information processing apparatus 100 generates the integrated KG 80 by aggregating the entities 64 and 73 and aggregating the entities 65 and 74 in the KGs 60 and 70. The integrated KG 80 includes entities 81, 82, 83, 84, 85, 86, 87, and 88. The entities 81, 82, 83, 86, 87, and 88 correspond to the entities 61, 62, 63, 71, 72, and 75, respectively. The entity 84 is an aggregation of the entities 64 and 73. The entity 85 is an aggregation of the entities 65 and 74. Note that, in the aggregation, the sentence corresponding to one of paired entities before the aggregation (for example, a sentence from the integrated KG) is used as the sentence corresponding to the entity after the aggregation.

The information processing apparatus 100 integrates a plurality of KGs in this manner, so that the integrated KG makes it possible to reach a failure cause that is not reachable from individual failure cases alone. To this end, the information processing apparatus 100 provides a function of accurately identifying combinations of entities that are semantically equivalent from KGs and generating an appropriate integrated KG.

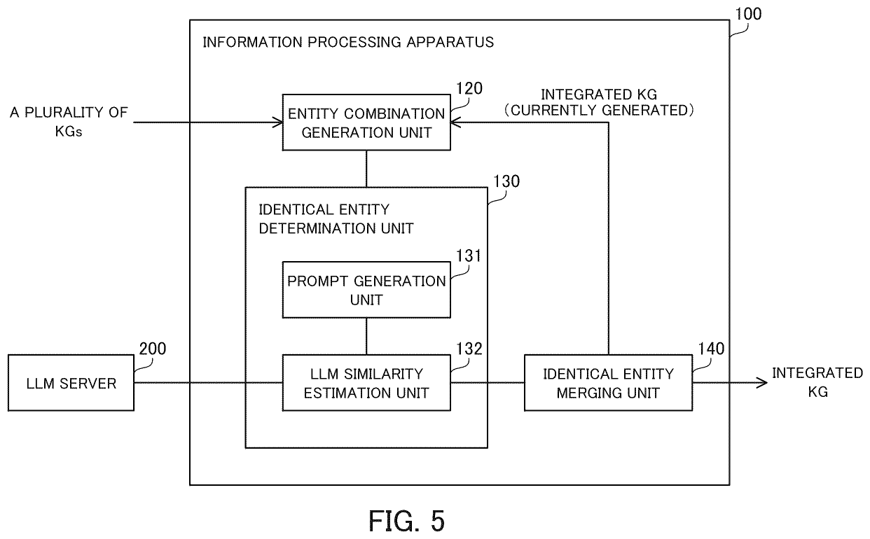

FIG. 5 illustrates an example of functions of the information processing apparatus.

The information processing apparatus 100 includes an entity combination generation unit 120, an identical entity determination unit 130, and an identical entity merging unit 140. The entity combination generation unit 120, the identical entity determination unit 130, and the identical entity merging unit 140 are implemented by the processor 101 executing a program stored in the RAM 102. Although not illustrated, the information processing apparatus 100 includes a data storage unit implemented by using the storage space of the RAM 102 and the HDD 103, and stores data to be used for processing of the information processing apparatus 100 in the data storage unit.

The entity combination generation unit 120 receives an input of a plurality of KGs to be integrated, and generates combinations (pairs) each containing an entity of one KG (input KG) among the plurality of KGs and an entity of the currently generated integrated KG. In the case where an integrated KG has not been generated, the entity combination generation unit 120 generates combinations each containing entities from two KGs among the plurality of input KGs. The entity combination generation unit 120 generates all possible pairs by extracting one entity from each of the two KGs.

The identical entity determination unit 130 determines, for each pair of entities generated by the entity combination generation unit 120, the equivalence of the two entities belonging to that pair. The identical entity determination unit 130 includes a prompt generation unit 131 and an LLM similarity estimation unit 132.

The prompt generation unit 131 generates prompts to be transmitted to the LLM server 200. The LLM server 200 is a server computer capable of communicating with the information processing apparatus 100 via the network 114. The LLM server 200 provides an LLM that outputs answers to natural language questions.

The prompt generation unit 131 generates a prompt requesting an answer as to the similarity between two entities. The prompt generation unit 131 includes, in the prompt, an instruction to decrease the similarity between the two entities or to treat the two entities as different entities if the two entities have a predetermined relationship such as a cause-effect relationship, a simultaneity relationship, or a subject-predicate relationship.

The LLM similarity estimation unit 132 estimates the similarity between two entities using the LLM provided by the LLM server 200, based on a prompt generated by the prompt generation unit 131. The similarity estimated using the LLM is referred to as an LLM similarity. The LLM similarity estimation unit 132 inputs the prompt to the LLM server 200, and acquires the LLM similarity estimated by the LLM based on the prompt from the LLM server 200.

In this connection, the LLM provided by the LLM server 200 may be, for example, GPT-4, GEMINI, or the like. In this connection, the information processing apparatus 100 may have an LLM in a local environment, such as Llama 2, Llama 3 or Command r+. In this case, the identical entity determination unit 130 may perform the LLM similarity estimation using the LLM in the local environment.

The identical entity determination unit 130 determines whether two entities are identical entities, based on the LLM similarity between the two entities. For example, the identical entity determination unit 130 compares the LLM similarity between two entities with a predetermined threshold. If the LLM similarity is greater than the threshold, the identical entity determination unit 130 determines that the two entities are identical entities. If the LLM similarity is less than or equal to the threshold, the identical entity determination unit 130 determines that the two entities are not identical entities.

The identical entity merging unit 140 merges two KGs by fusing two entities determined to be identical entities by the identical entity determination unit 130.

Then, the entity combination generation unit 120 generates new combinations of two entities using the next input KG among the plurality of input KGs and the currently generated integrated KG. Then, the identical entity determination unit 130 and the identical entity merging unit 140 repeat their processes. When the integration of the plurality of KGs into the integrated KG is completed in this way, the identical entity merging unit 140 outputs information on the final integrated KG.

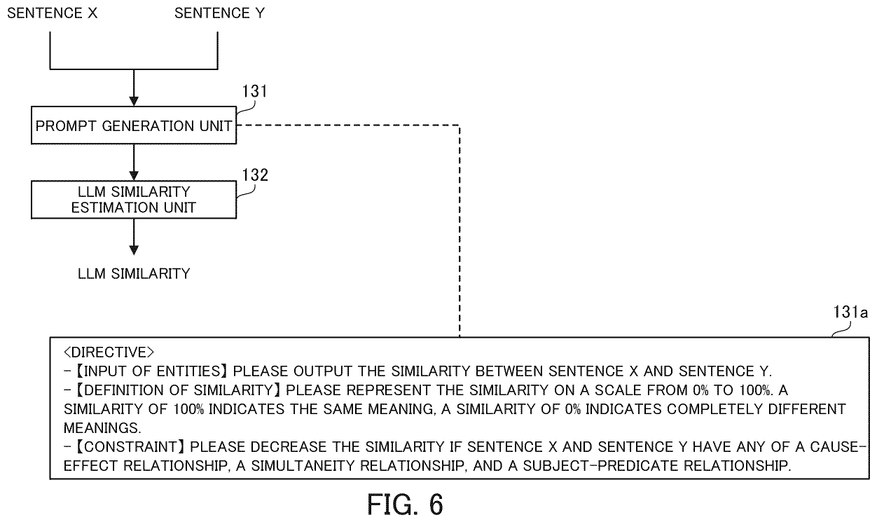

FIG. 6 illustrates an example of a prompt.

A prompt 131a is an example of a prompt generated by the prompt generation unit 131. The prompt generation unit 131 generates the prompt 131a for two entities, that is, a sentence X and a sentence Y.

The prompt 131a includes a definition of LLM similarity and an instruction to decrease the similarity (LLM similarity) between two entities if the relationship between the two entities satisfies any one (for example, cause and effect, simultaneity, subject and predicate, or the like) listed in a relationship list prepared in advance.

For example, the prompt 131a includes a statement, “Please output the similarity between sentence X and sentence Y.”, as a directive that includes an input of entities and an instruction to output their LLM similarity. In addition, the prompt 131a includes a statement, “Please represent the similarity on a scale from 0% to 100%. A similarity of 100% indicates the same meaning, and a similarity of 0% indicates completely different meanings.”, as a definition of the LLM similarity. The prompt 131a also includes a statement, “Please decrease the similarity if sentence X and sentence Y have any of a cause-effect relationship, a simultaneity relationship, and a subject-predicate relationship.”, as a constraint on the LLM similarity.

The LLM similarity estimation unit 132 estimates the LLM similarity between the two entities (sentences X and Y) using the LLM on the basis of the prompt 131a.

Next, a processing procedure of the information processing apparatus 100 will be described.

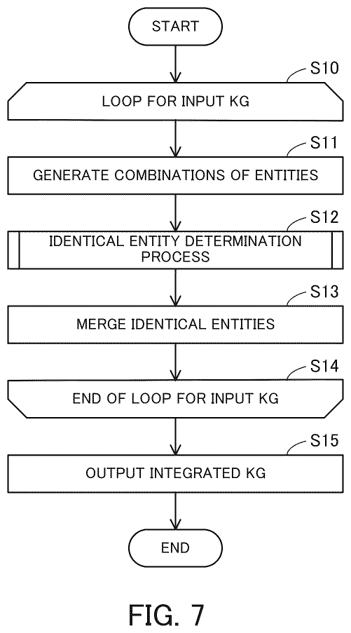

FIG. 7 is a flowchart illustrating an example of generating an integrated knowledge graph.

(S10) The information processing apparatus 100 repeats steps S11 to S13 for each received KG (input KG) that is sequentially input (loop for input KG). In the case where step S10 is executed for the first time, the information processing apparatus 100 executes steps S11 and

S13, treating one of the first two input KGs as an integration destination KG (integrated KG).

(S11) The entity combination generation unit 120 generates, from the input KG and the integrated KG, combinations each containing an entity of the input KG and an entity of the integrated KG. For example, the entity combination generation unit 120 exhaustively generates all possible combinations.

(S12) The identical entity determination unit 130 performs an identical entity determination process based on of identical entity LLM similarity. Details the determination process will be described later.

(S13) The identical entity merging unit 140 merges entities determined to be identical entities by the identical entity determination unit 130, to incorporate the input KG into the integrated KG. That is, the identical entity merging unit 140 aggregates each entity of the input KG determined to be identical to an entity of the integrated KG, into its corresponding entities of the integrated KG. Accordingly, each corresponding entity of the integrated KG inherits the connections that the aggregated entity had with other entities in the input KG.

(S14) When the integration of all of the plurality of KGs into the integrated KG is completed, the information processing apparatus 100 completes the loop for input KG, and proceeds to step S15.

(S15) The identical entity merging unit 140 outputs information on the generated integrated KG.

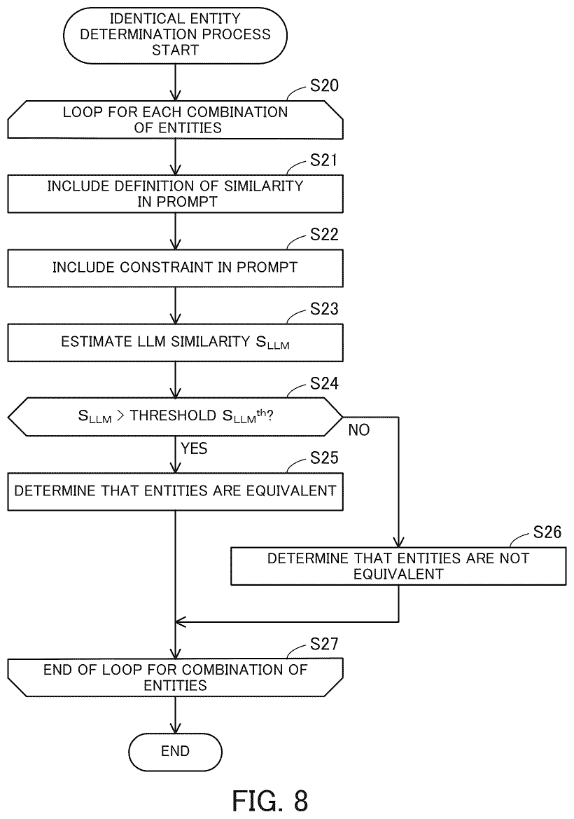

FIG. 8 is a flowchart illustrating an example of the identical entity determination process.

The identical entity determination process corresponds to step S12.

(S20) The identical entity determination unit 130 repeats steps S21 to S26 for each combination of entities.

(S21) The prompt generation unit 131 generates a prompt that includes an instruction to output the LLM similarity between two entities, and includes the definition of the LLM similarity in the prompt.

(S22) The prompt generation unit 131 includes, in the prompt, a constraint to decrease the LLM similarity between two entities if the relationship between the two entities matches any of predetermined relationships such as cause and effect, simultaneity, subject and predicate.

(S23) The LLM similarity estimation unit 132 estimates the LLM similarity S_{LLM} using the LLM for the two entities. For example, the LLM similarity estimation unit 132 inputs the prompt generated by the prompt generation unit 131 into the LLM server 200, and acquires the LLM similarity S_{LLM} from the LLM server 200.

(S24) The identical entity determination unit 130 determines whether the LLM similarity S_{LLM} is greater than a threshold S_{LLM}^{th}. If the LLM similarity S_{LLM} is greater than the threshold S_{LLM}^{th}, the process proceeds to step S25. If the LLM similarity S_{LLM} is less than or equal to the threshold S_{LLM}^{th}, the process proceeds to step S26.

(S25) The identical entity determination unit 130 determines that the two entities are equivalent. Then, the process proceeds to step S27.

(S26) The identical entity determination unit 130 determines that the two entities are not equivalent. Then, the process proceeds to step S27.

(S27) After repeating steps S21 to S26 for all combinations of entities generated from the input KG and the integrated KG, the identical entity determination unit 130 completes the repetition. Then, the identical entity determination unit 130 notifies the identical entity merging unit 140 of information on the combinations of two entities determined to be equivalent in step S25, and completes the identical entity determination process.

For example, no combination may be found in which entities are determined to be identical entities between the input KG and the integrated KG. In this case, the identical entity merging unit 140 may incorporate the input KG into the integrated KG without aggregating any entities. In this case, the integrated KG includes a plurality of KGs in distinct lineages, including the existing integrated KG and the input KG.

As described above, the information processing apparatus 100 includes, in a prompt to be used for estimating LLM similarity, a constraint to decrease the LLM similarity between two entries if the relationship between the two entities is a predetermined relationship. By doing so, the information processing apparatus 100 is able to improve the accuracy of LLM similarity estimation.

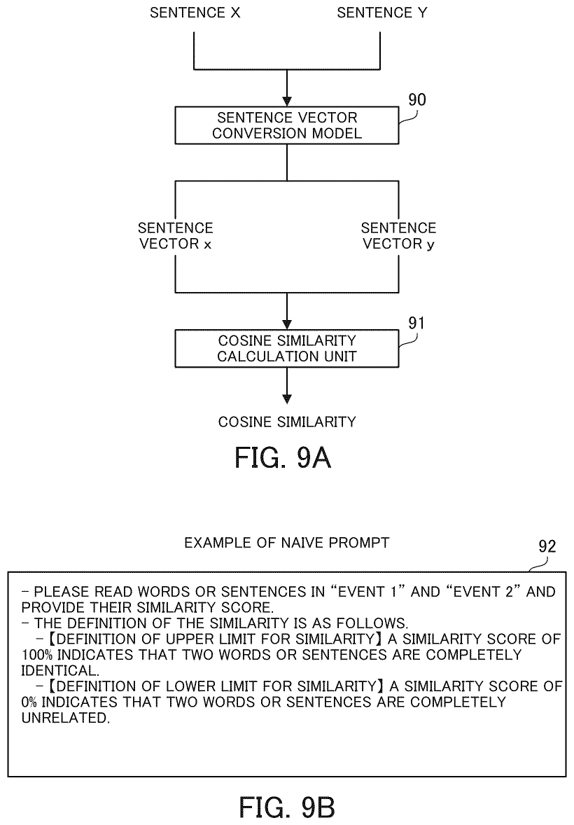

FIGS. 9A and 9B illustrate comparative examples of a similarity estimation method.

As a first comparative example of the similarity estimation method for two entities, a method of estimating cosine similarity is considered. FIG. 9A illustrates an example of obtaining a cosine similarity between sentences X and Y. In order to obtain the cosine similarity, first, the sentence X is converted into a sentence vector x and the sentence Y is converted into a sentence vector y by a sentence vector conversion model 90. The sentence vector conversion model 90 is a machine learning model that vectorizes sentences. The sentence vector conversion model 90 may also be described as a language model that vectorizes sentences. The sentence vector x is a vector having a plurality of features related to the sentence X as elements. The sentence vector y is a vector having a plurality of features related to the sentence Y as elements.

Then, the cosine similarity between the sentence vectors x and y is calculated by a cosine similarity calculation unit 91, which is implemented by the information processing apparatus 100 or the like. For example, Equation (1) is used to calculate the cosine similarity.

$$\begin{matrix}cos ( x , y ) = \frac{〈 x , y 〉}{‖ x ‖ ‖ y ‖} \\ = \frac{{\sum }_{k = 1}^{n} {x}_{k} {y}_{k}}{\sqrt{{\sum }_{k = 1}^{n} {x}_{k}^{2}} \sqrt{{\sum }_{k = 1}^{n} {y}_{k}^{2}}}\end{matrix} \qquad ( 1 )$$

As a second comparative example of the similarity estimation method for two entities, a method using a “naive prompt” as a prompt for LLM similarity estimation is conceivable. The “naive prompt” is a prompt that does not include any constraint as exemplified in the prompt 131a. FIG. 9B exemplifies a naive prompt 92. The prompt 92 does not include any constraint on LLM similarity.

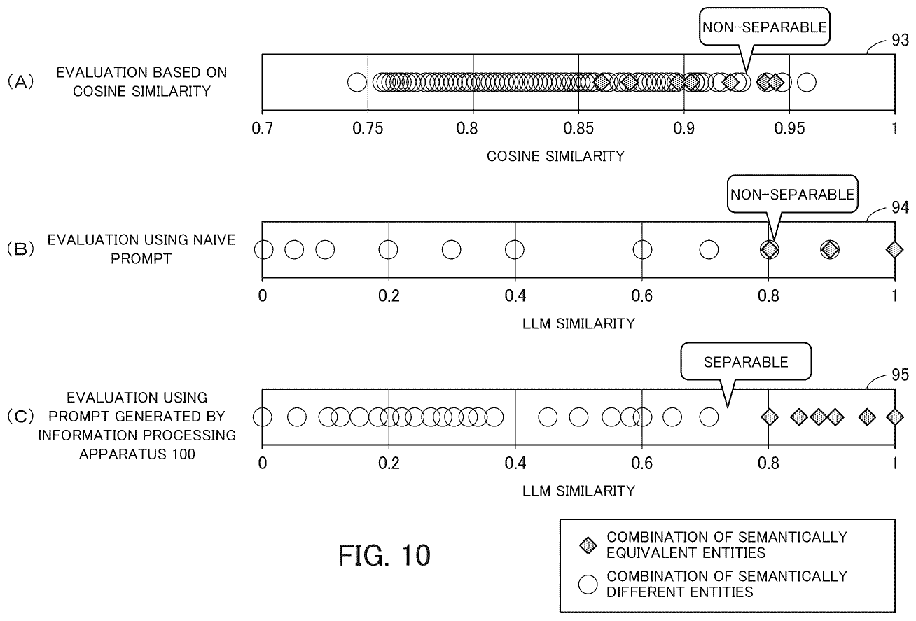

FIG. 10 illustrates an example of similarity evaluation results obtained with some similarity estimation methods.

FIG. 10 exemplifies results of evaluating two entities, which are already determined to be semantically equivalent or different, using the followings: a cosine similarity, an LLM similarity obtained based on a naive prompt, and an LLM similarity obtained based on a prompt generated by the information processing apparatus 100.

(A) of FIG. 10 illustrates an evaluation result 93 obtained based on a cosine similarity. (B) of FIG. 10 illustrates an evaluation result 94 obtained based on an LLM similarity using a naive prompt. (C) of FIG. 10 illustrates an evaluation result 95 obtained based on an LLM similarity using a prompt including a constraint, which is generated by the information processing apparatus 100. The horizontal axis of the evaluation result 93 represents cosine similarity. The horizontal axis of each evaluation result 94 and 95 represents LLM similarity. In the evaluation results 93, 94, and 95, pairs of entities that are semantically equivalent are plotted as squares, and pairs of entities that are semantically different are plotted as circles.

The evaluation result 93 reveals that the cosine similarity is unable to appropriately separate pairs of entities that are semantically equivalent from pairs of entities that are semantically different. The evaluation result 94 reveals that the LLM similarity obtained using a naive prompt is also unable to appropriately separate pairs of entities that are semantically equivalent from pairs of entities that are semantically different.

In contrast, the evaluation result 95 indicates that the LLM similarity obtained using a prompt including a constraint is able to appropriately separate pairs of entities that are semantically equivalent from pairs of entities that are semantically different. That is to say, the information processing apparatus 100 is able to improve the accuracy of LLM similarity estimation between two entities.

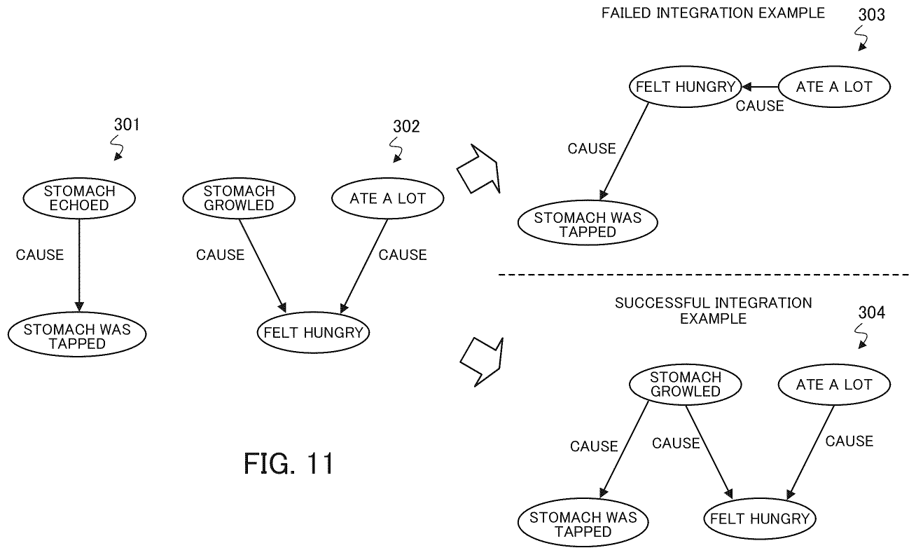

FIG. 11 illustrates examples of integration of knowledge graphs.

Here, when LLM similarity is calculated, there may a case where two entities having a cause-and-effect relationship are determined to be semantically similar. However, in a KG where identification of causal relationship is needed, it is preferable to exclude the cause-and-effect relationship from consideration in estimating the LLM similarity.

For example, a KG 301 indicates that the cause of the entity “stomach echoed” is the entity “stomach was tapped”. A KG 302 indicates that the cause of the entity “stomach growled” is the entity “felt hungry”. In addition, the KG 302 indicates that the cause of the entity “ate a lot” is the entity “felt hungry”.

In the case where the KGs 301 and 302 are integrated, the entity “stomach echoed” in the KG 301 may be determined to be semantically equivalent to the entity “stomach growled” in the KG 302. In this case, the entity “stomach echoed” in the KG 301 may be determined to be semantically similar to the entity “felt hungry”, which is the cause of the entity “stomach growled” in the KG 302.

Then, as illustrated in a failed integration example, a KG 303 may be generated in which three entities, i.e., “stomach echoed”, “stomach growled”, and “felt hungry” are all merged into one entity “felt hungry”. In the KG 303, the causal relationship between the entity “stomach growled” and the entity “felt hungry” (or the causal relationship between the entity “stomach echoed” and the entity “felt hungry”) is lost.

To avoid this, the information processing apparatus 100 includes, in a prompt, an instruction to decrease LLM similarity between two entities if the two entities have a predetermined relationship such as cause and effect, simultaneity, or subject and predicate, together with an instruction to output the LLM similarity. By doing so, the information processing apparatus 100 is able to improve the accuracy of the LLM similarity estimation.

Specifically, in the example of the KGs 301 and 302, the entity “stomach echoed” in the KG 301 and the entity “stomach growled” in the KG 302 may be determined to be semantically equivalent. In this case, the entity “felt hungry” in the KG 302 is determined to be the cause of the entity “stomach echoed” in the KG 301, which is considered to be identical to the entity “stomach growled” in the KG 302. Then, the LLM similarity estimated for the pair of the entity “stomach echoed” in KG 301 and the entity “felt hungry” in KG 302, which is the cause of the entity “stomach echoed” becomes relatively low. As a result, the information processing apparatus 100 is able to generate a KG 304 that includes the causal relationship between the entity “stomach growled” and the entity “felt hungry” (or the causal relationship between the entity “stomach echoed” and the entity “felt hungry”), as illustrated in a successful integration example.

Here, in order to further increase the accuracy of the LLM similarity, the information processing apparatus 100 may use a technique such as tree of thought (ToT) or in-context learning (ICL) in prompt generation.

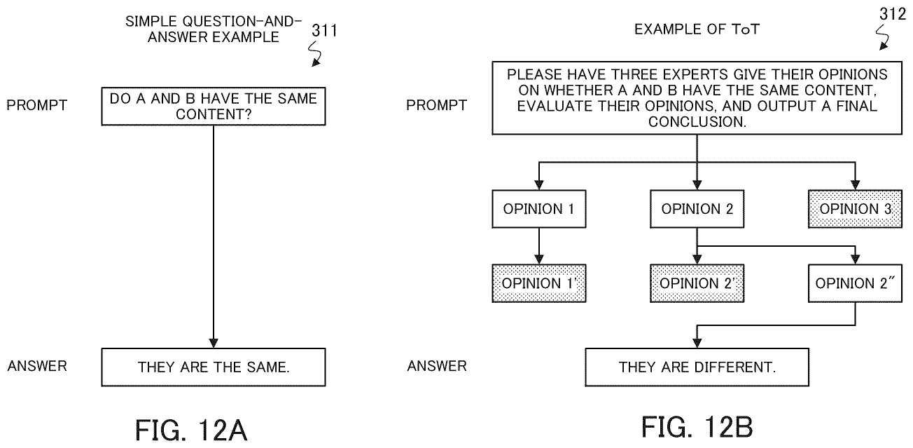

FIGS. 12A and 12B are diagrams for describing ToT.

ToT is a prompting method in which an LLM is caused to generate a plurality of opinions to a given question, to repeat self-evaluation and deep examination for each opinion, and to output a final answer as a conclusion. FIG. 12A illustrates a flow 311 representing a

simple question-and-answer example. The flow 311 represents a process in which, in response to a very simple prompt “Do A and B have the same content?”, an LLM outputs an answer “They are the same”. With such a very simple prompt, the LLM directly outputs an answer to the prompt and does not verify the answer.

FIG. 12B illustrates a flow 312 representing an example of ToT. The flow 312 represents a process in which, in response to a prompt “Please have three experts give their opinions on whether A and B have the same content, evaluate their opinions, and output a final conclusion”, an LLM outputs an answer “They are different”. The flow 312 includes a plurality of opinions 1 to 3, 1′, 2′, and 2″ output by the LLM in the course of deriving the answer. The opinions 1, 2, and 2″ are in favor. The opinions 1′, 2′, and 3 are negative. In this manner, the information processing apparatus 100 may obtain, from the LLM, an answer based on a consensus decision made by a plurality of virtual respondents, using a prompt constructed based on ToT. With the use of the ToT technique, the information processing apparatus 100 is able to further improve the accuracy of LLM similarity estimation between entities.

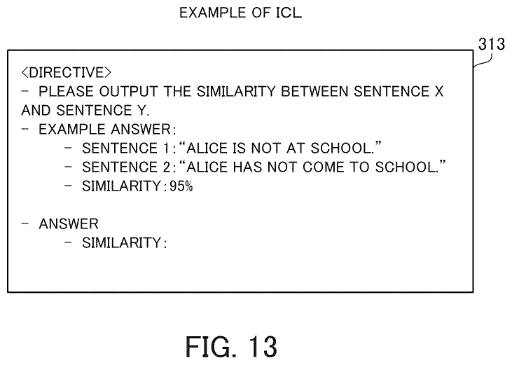

FIG. 13 is a diagram for describing ICL.

ICL is a technique for improving the accuracy of an LLM-generated answer by including hints for answering a question, such as example answers to the question, in a prompt.

A prompt 313 indicates an example of a directive based on ICL. For example, the prompt generation unit 131 may include, for a question “Please output the similarity between sentence X and sentence Y”, an example answer indicating that the similarity between sentence 1 “Alice is not at school” and sentence 2 “Alice has not come to school” is “95%”. With the use of the LCL technique, the information processing apparatus 100 is able to further improve the accuracy of LLM similarity estimation between entities.

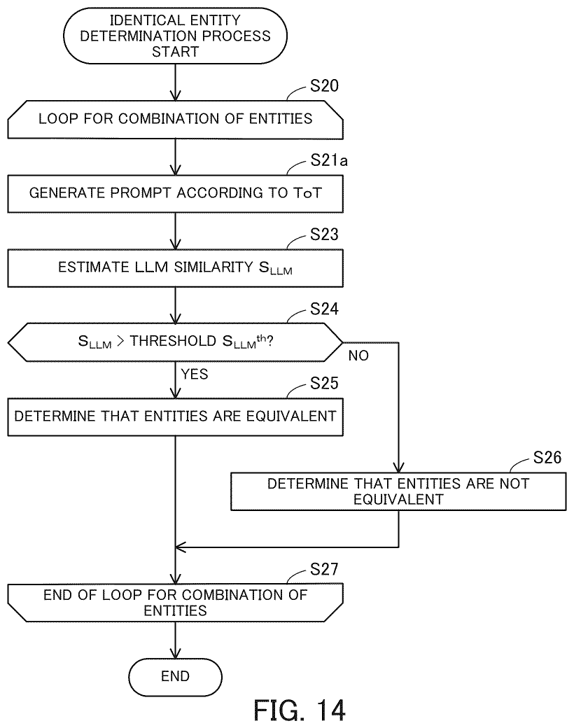

FIG. 14 is a flowchart illustrating a modification of the identical entity determination process.

The identical entity determination process corresponds to step S12.

The process of FIG. 14 is different from that of FIG. 8 in that step S21a is executed instead of steps S21 and S22 included in the process illustrated in FIG. 8. Hereinafter, step S21a will be mainly described, and description of steps S20 and S23 to S27 will be omitted. Step S21a is executed in the loop for the combination of entities in step S20.

(S21a) The prompt generation unit 131 generates a prompt according to ToT. The prompt generation unit 131 may generate a prompt according to ICL, instead of ToT. The prompt generation unit 131 may generate a prompt using both the ToT and ICL techniques. With the combination of the ToT and ICL techniques, the prompt generation unit 131 may improve the accuracy of LLM similarity estimation, as compared to the case of using ToT or ICL alone. In step S21a, the prompt generation unit 131 also includes, in the prompt, the definition of similarity as in step S21 and the constraint as in step S22. Then, the process proceeds to step S23.

Next, specific examples of prompts generated according to ToT and ICL by the prompt generation unit 131 will be described.

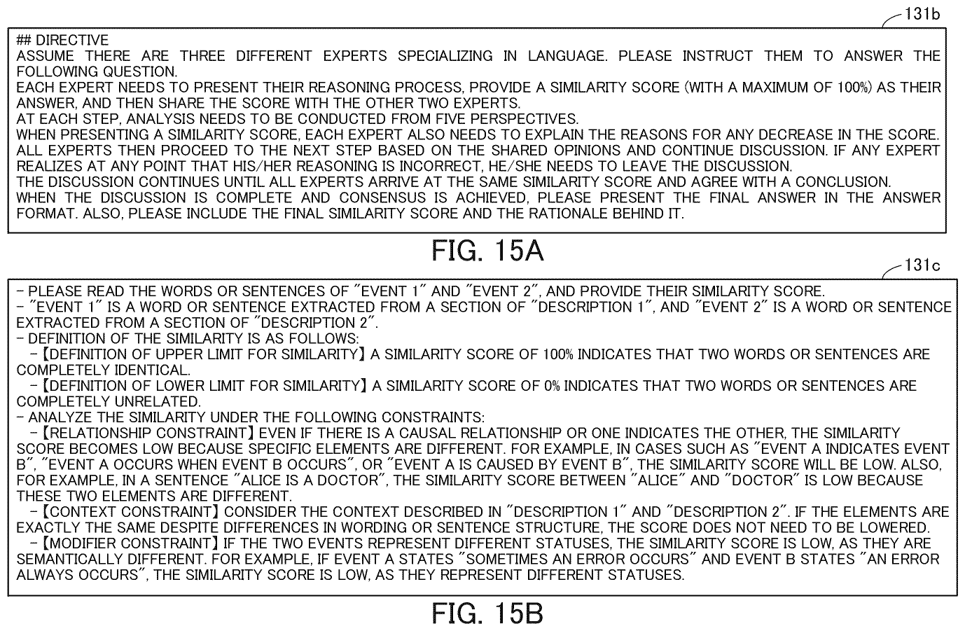

FIGS. 15A and 15B illustrate examples of prompts.

A prompt 131b is an example of a prompt according to ToT. The prompt 131b includes, for example, a statement instructing the output of an answer based on a consensus decision to be made by three experts.

A prompt 131c is an example of a prompt including an input of two entities, a definition of similarity, and a description of constraints.

Each of “event 1” and “event 2” in the prompt 131c corresponds to an entity. “Description 1” in the prompt 131c is a description before and after the “event 1” (a section from which the “event 1” is extracted) in the first document. “Description 2” is a description before and after the “event 2” in the second document (a section from which the “event 2” is extracted).

The prompt generation unit 131 specifies an upper limit of 100% for LLM similarity and a lower limit of 0% for LLM similarity in the prompt 131c, thereby acquiring an LLM similarity using a value ranging from 0% to 100%.

The prompt 131c includes the following statement as a “relationship constraint”.

“Even if there is a causal relationship or one indicates the other, the similarity score becomes low because specific elements are different. For example, in cases such as “event A indicates event B”, “event A occurs when event B occurs”, or “event A is caused by event B”, the similarity score will be low. Also, for example, in a sentence “Alice is a doctor”, the similarity score between “Alice” and “doctor” is low, as these two elements are different.”

The prompt 131c includes, under the “relationship constraint”, specific examples of a relationship between entities according to ICL. “Event A indicates event B” is a specific example of a relationship in which “event A” suggests “event B”. “Event A occurs when event B occurs” is a specific example of a case where “event A” and “event B” have a simultaneity relationship. “Event A is caused by event B” is a specific example of a case where there is a relationship in which “event B” is the cause and “event A” is the effect. “Alice is a doctor” is a specific example of a case where there is a relationship in which “Alice” (event A or event B) is the subject and “doctor” (event B or event A) is the predicate.

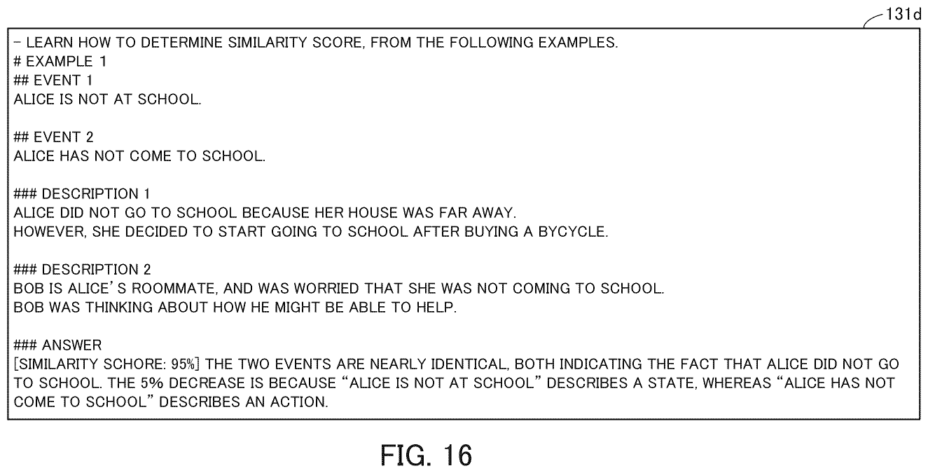

FIG. 16 illustrates an example (continuation) of a prompt.

A prompt 131d is an example of a prompt according to ICL. The prompt 131d includes a specific example of each of “event 1” extracted from “description 1” and “event 2” extracted from “description 2”, and an example answer indicating the LLM similarity between “event 1” and “event 2”. As illustrated in the prompt 131d, the prompt generation unit 131 may include, in addition to the example answer indicating an LLM similarity, an example of an output describing the rationale for the LLM similarity determination.

In this way, the information processing apparatus 100 is able to further improve the accuracy of LLM similarity estimation between entities using the ToT and ICL techniques. The information processing apparatus 100 is able to use the prompts 131b, 131c, and 131d in combination as appropriate. For example, the information processing apparatus 100 may acquire an LLM similarity using the prompts 131c and 131d, without using the prompt 131b. The information processing apparatus 100 may acquire an LLM similarity using the prompts 131b and 131c, without using the prompt 131d. The information processing apparatus 100 may acquire an LLM similarity using only the prompt 131c among the prompts 131b, 131c, and 131d. In the case where the prompt 131d is not used, the prompt generation unit 131 does not need to include sentences related to “description 1” and “description 2” in the prompt 131c.

### Third Embodiment

Next, a third embodiment will be described. Features different from those of the second embodiment will be mainly described, and description of the same features will be omitted.

The information processing apparatus 100 according to the third embodiment provides a function of filtering combinations of entities for LLM similarity estimation.

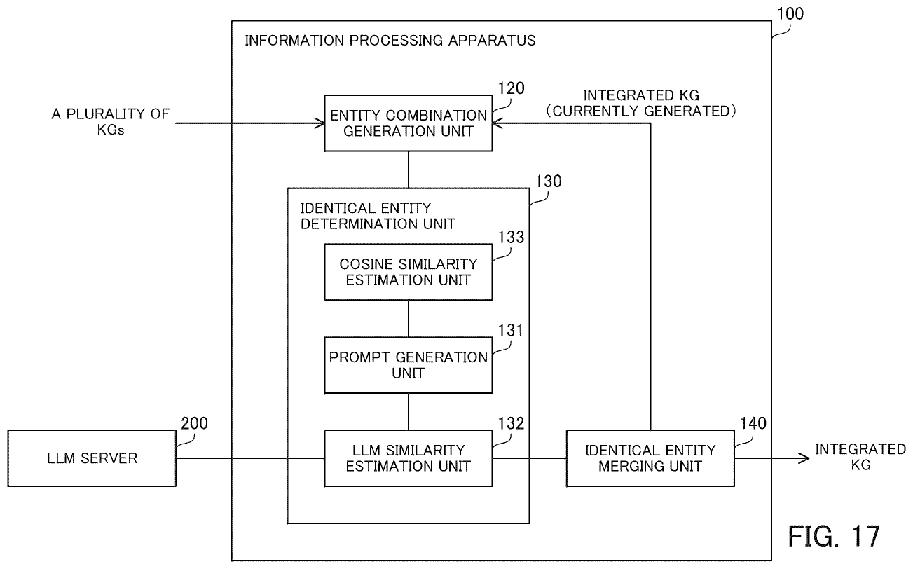

FIG. 17 illustrates an example of functions of the information processing apparatus according to the third embodiment.

The information processing apparatus 100 includes the entity combination generation unit 120, the identical entity determination unit 130, and the identical entity merging unit 140. Here, the third embodiment is different from the second embodiment in that the identical entity determination unit 130 includes a cosine similarity estimation unit 133 in addition to the prompt generation unit 131 and the LLM similarity estimation unit 132.

The cosine similarity estimation unit 133 estimates a cosine similarity for each combination of entities generated by the entity combination generation unit 120. The cosine similarity estimation unit 133 compares the cosine similarity with a threshold, and selects a combination in which the cosine similarity is greater than the threshold, as a combination for which an LLM similarity is to be estimated.

As illustrated in FIG. 9A, the cosine similarity estimation unit 133 converts each entity into a sentence vector using a sentence vector conversion model, and calculates the cosine similarity of Equation (1) for the sentence vector.

The prompt generation unit 131 generates a prompt for each combination of entities whose cosine similarity is greater than the threshold. The LLM similarity estimation unit 132 uses the prompt to estimate the LLM similarity for each combination of entities whose cosine similarity is greater than the threshold.

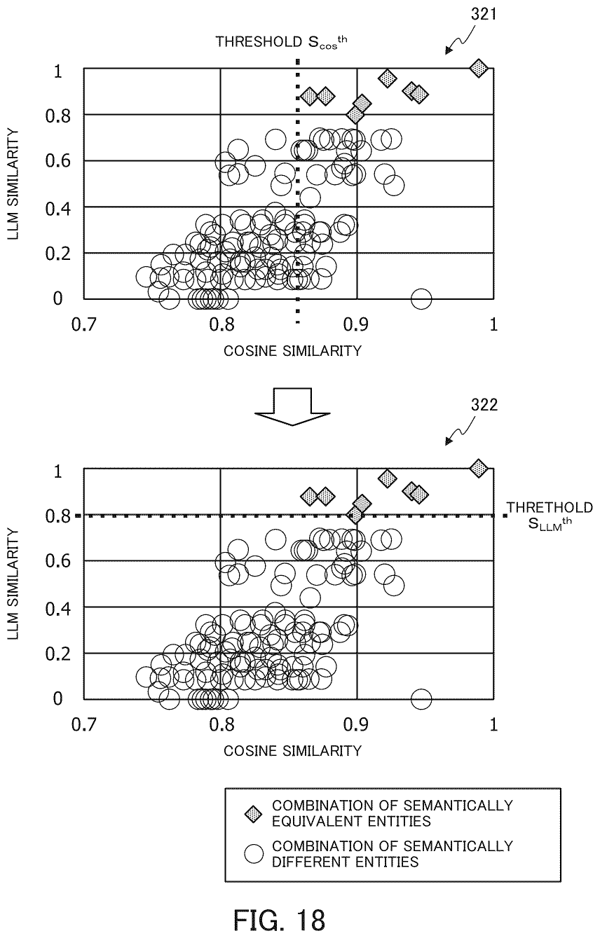

FIG. 18 illustrates an example of filtering based on cosine similarity.

Graphs 321 and 322 are plot examples of cosine similarity and LLM similarity obtained for combinations of entities that are semantically equivalent and combinations of entities that are semantically different. The horizontal axes of the graphs 321 and 322 represent cosine similarity. The vertical axes of the graphs 321 and 322 represent LLM similarity.

The graph 321 indicates a threshold S_{cos}^{th} for the cosine similarity. The graph 322 indicates a threshold S_{LLM}^{th} for the LLM similarity. As indicated by the graph 321, the information processing apparatus 100 is able to filter candidates for combinations of entities that are semantically equivalent, by comparing the cosine similarity with the threshold S_{cos}^{th}. The information processing apparatus 100 is able to reduce the number of combinations of entities for which an LLM similarity is to be estimated, by performing the filtering based on the cosine similarity, which leads to a reduction in the processing load related to the LLM similarity estimation. In addition, the information processing apparatus 100 is able to determine combinations of entities that are semantically equivalent at high speed. Furthermore, the information processing apparatus 100 is able to increase the accuracy of determining combinations of entities that are semantically equivalent.

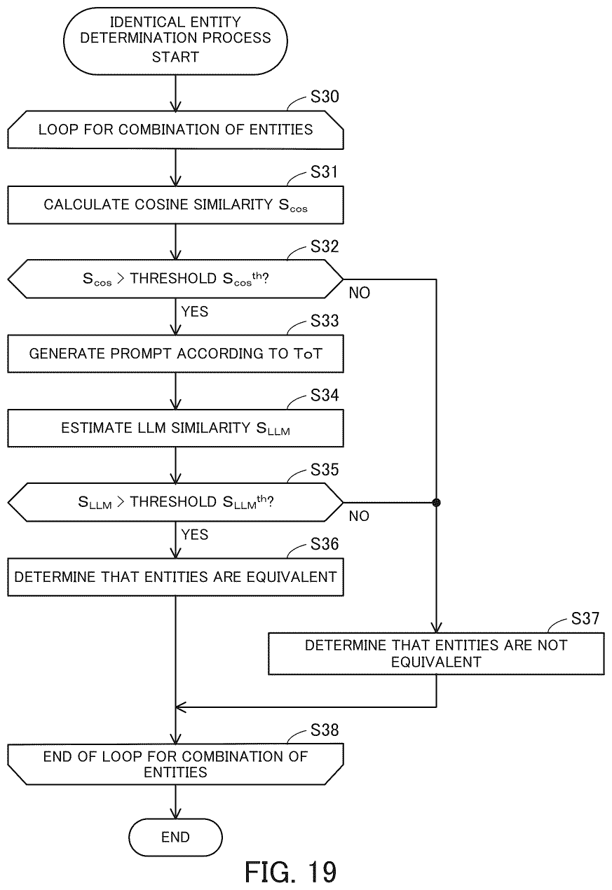

FIG. 19 is a flowchart illustrating an example of the identical entity determination process.

The information processing apparatus 100 of the third embodiment performs the following process instead of the process of the second embodiment illustrated in FIG. 8. The identical entity determination process corresponds to step S12.

(S30) The identical entity determination unit 130 repeats steps S31 to S37 for a combination of entities.

(S31) The cosine similarity estimation unit 133 calculates a cosine similarity S_{cos} between the two entities.

(S32) The cosine similarity estimation unit 133 determines whether the cosine similarity S_{cos} is greater than a threshold S_{cos}^{th}. If the cosine similarity S_{cos} is greater than the threshold S_{cos}^{th}, the process proceeds to step S33. If the cosine similarity S_{cos} is less than or equal to the threshold S_{cos}^{th}, the process proceeds to step S37.

(S33) The prompt generation unit 131 generates a prompt according to ToT. The prompt generation unit 131 may generate a prompt according to ICL instead of ToT. The prompt generation unit 131 may generate a prompt using both the ToT and ICL techniques. The prompt generation unit 131 may improve the accuracy of LLM similarity estimation by using a prompt based on the combination of the ToT and ICL techniques, as compared to the case of using the ToT or ICL alone. In step S33, the prompt generation unit 131 also includes, in the prompt, the definition of similarity as in step S21 and the constraint as in step S22.

(S34) The LLM similarity estimation unit 132 estimates an LLM similarity S_{LLM} between the two entities using an LLM. For example, the LLM similarity estimation unit 132 inputs the prompt generated by the prompt generation unit 131 to the LLM server 200, and acquires the LLM similarity S_{LLM} from the LLM server 200.

(S35) The identical entity determination unit 130 determines whether the LLM similarity S_{LLM} is greater than a threshold S_{LLM}^{th}. If the LLM similarity S_{LLM} is greater than the threshold Smith, the process proceeds to step S36. If the LLM similarity S_{LLM} is less than or equal to the threshold S_{LLM}^{th}, the process proceeds to step S37.

(S36) The identical entity determination unit 130 determines that the two entities are equivalent. Then, the process proceeds to step S38.

(S37) The identical entity determination unit 130 determines that the two entities are not equivalent. Then, the process proceeds to step S38.

(S38) After repeating steps S31 to S37 for all combinations of entities generated from the input KG and the integrated KG, the identical entity determination unit 130 completes the repetition. Then, the identical entity determination unit 130 notifies the identical entity merging unit 140 of information on the two entities determined to be equivalent in step S36, and completes the identical entity determination process.

In the process of FIG. 19, the prompt generation unit 131 may execute steps S21 and S22 instead of step S33. That is, the prompt generation unit 131 does not need to use the ToT or ICL technique in generating a prompt.

In this way, the information processing apparatus 100 is able to reduce the number of combinations of entities for which an LLM similarity is to be estimated, by filtering candidates using the cosine similarity for the combinations of entities for which an LLM similarity is to be estimated. Therefore, the information processing apparatus 100 is able to reduce the processing load of the LLM server 200 related to the LLM similarity estimation. Further, the information processing apparatus 100 is able to omit steps S33 to S35 in proportion to the reduction in the number of combinations of entities for which an LLM similarity is to be estimated. Therefore, the information processing apparatus 100 is able to speed up the determination of combinations of entities that are semantically equivalent. As a result, the information processing apparatus 100 is able to speed up the generation of an integrated KG.

### Fourth Embodiment

Next, a fourth embodiment will be described. Features different from those of the second and third embodiments will be mainly described, and description of the same features will be omitted.

Here, the information processing apparatus 100 determines that entities whose LLM similarity is greater than a threshold are identical entities, and fuses the entities in the two KGs to generate an integrated KG. In this case, if an entity in one KG is determined to be identical to a plurality of entities in the other KG, the plurality of entities in the other KG may be aggregated into one entity in the integrated KG. In this case, information contained in the original KGs may be excessively lost in the integrated KG.

To avoid this, the information processing apparatus 100 of the fourth embodiment provides a function of integrating KGs such that information contained in the original KGs is appropriately reflected in an integrated KG.

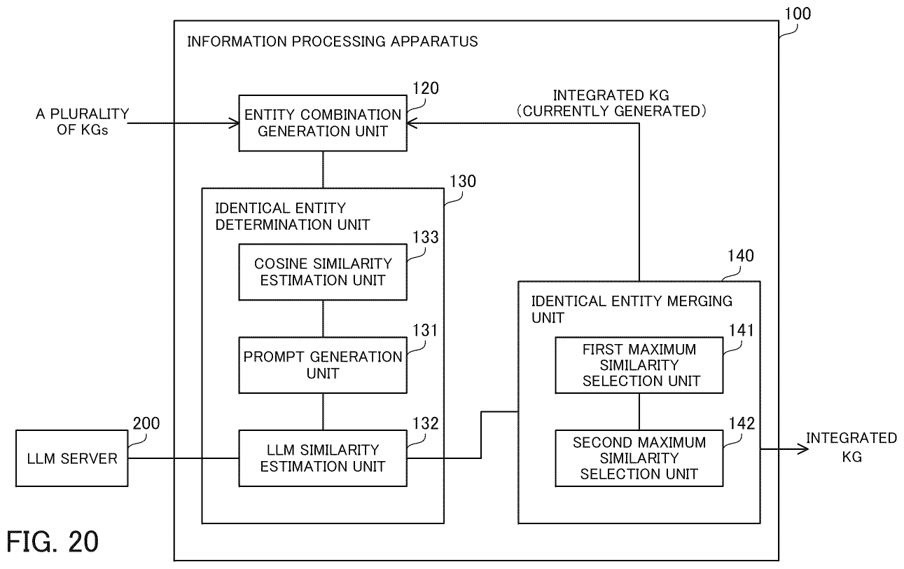

FIG. 20 illustrates an example of functions of the information processing apparatus according to the fourth embodiment.

The information processing apparatus 100 includes the entity combination generation unit 120, the identical entity determination unit 130, and the identical entity merging unit 140. Here, the fourth embodiment is different from the third embodiment in that the identical entity merging unit 140 includes a first maximum similarity selection unit 141 and a second maximum similarity selection unit 142.

The first maximum similarity selection unit 141 acquires combinations (pairs) of entities whose LLM similarity is determined to be greater than a threshold from the identical entity determination unit 130. The first maximum similarity selection unit 141 selects, for each entity in the input KG, a pair having the maximum LLM similarity with an entity in the integrated KG, from all the acquired combinations.

The second maximum similarity selection unit 142 selects, for each entity in the integrated KG, a pair having the maximum LLM similarity with an entity in the input KG, from the pairs selected by the first maximum similarity selection unit 141.

The identical entity merging unit 140 merges the input KG into the integrated KG by fusing the entity of the input KG belonging to each pair selected by the second maximum similarity selection unit 142 into the corresponding entity of the integrated KG.

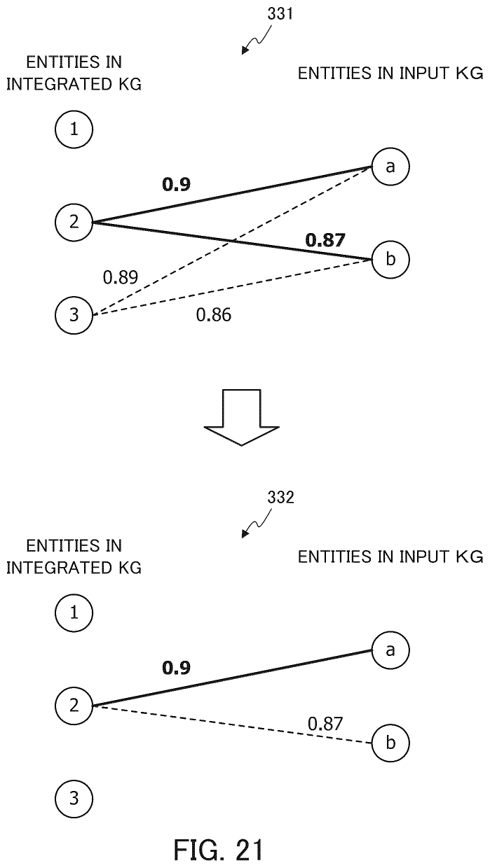

FIG. 21 illustrates an example of selecting a combination of entities to be fused.

In FIG. 21, three “entities 1, 2, and 3” are entities in an integrated KG. Two “entities a and b” are entities in an input KG. It is assumed that the identical entity merging unit 140 acquires four combinations of entities (2, a), (2, b), (3, a), and (3, b) from the identical entity determination unit 130.

The LLM similarity of the combination (2, a) is 0.9. The LLM similarity of the combination (2, b) is 0.87. The LLM similarity of the combination (3, a) is 0.89. The LLM similarity of the combination (3, b) is 0.86.

First, the first maximum similarity selection unit 141 selects, for each entity in the input KG, a combination having the maximum LLM similarity from all the acquired combinations (2, a), (2, b), (3, a), and (3, b). Among the combinations (2, a) and (3, a) for the “entity a”, a combination having the maximum LLM similarity is (2, a). Among the combinations (2, b) and (3, b) for the “entity b”, a combination having the maximum LLM similarity is (2, b). Therefore, the first maximum similarity selection unit 141 selects the combinations (2, a) and (2, b). A diagram 331 illustrates this selection example made by the first maximum similarity selection unit 141.

The second maximum similarity selection unit 142 selects, for each entity in the integrated KG, a combination having the maximum LLM similarity from the combinations (2, a) and (2, b) selected by the first maximum similarity selection unit 141. Among the combinations (2, a) and (2, b) for the “entity 2”, a combination having the maximum LLM similarity is (2, a). Therefore, the second maximum similarity selection unit 142 selects the combination (2, a). A diagram 332 illustrates this selection example made by the second maximum similarity selection unit 142.

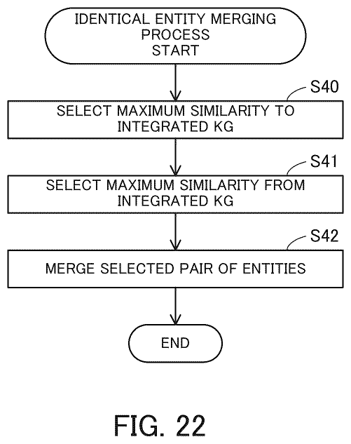

FIG. 22 is a flowchart illustrating an example of an identical entity merging process.

The identical entity merging process corresponds to step S13.

(S40) The first maximum similarity selection unit 141 acquires combinations (pairs) of entities whose LLM similarity is determined to be greater than a threshold from the identical entity determination unit 130. The first maximum similarity selection unit 141 performs a process of selecting the maximum similarity to the integrated KG. Specifically, the first maximum similarity selection unit 141 selects, for each entity in the input KG, a pair having the maximum LLM similarity with an entity in the integrated KG from among all the combinations acquired from the identical entity determination unit 130.

(S41) The second maximum similarity selection unit 142 performs a process of selecting the maximum similarity from the integrated KG. Specifically, the second maximum similarity selection unit 142 selects, for each entity in the integrated KG, a pair having the maximum LLM similarity with an entity in the input KG from among the pairs selected by the first maximum similarity selection unit 141.

(S42) The identical entity merging unit 140 merges (fuses), for each pair selected by the second maximum similarity selection unit 142, the entity of the input KG and the entity of the integrated KG, which belong to the pair, to incorporate the input KG into the integrated KG.

The information processing apparatus 100 of the fourth embodiment appropriately performs filtering to obtain pairs of an entity of the input KG and an entity of the integrated KG to be merged. Therefore, the information processing apparatus 100 is able to appropriately reflect information contained in the input KG in the integrated KG. For example, the information processing apparatus 100 is able to reduce the likelihood that the integrated KG lacks the information due to the entities of the input KGs being excessively aggregated in the process of integrating the KGs. In this way, the information processing apparatus 100 is able to efficiently generate an integrated KG having an appropriate amount of information.

### Fifth Embodiment

Next, a fifth embodiment will be described. Features different from the second to fourth embodiments described above will be mainly described, and description of the same features will be omitted. The information processing apparatus 100 may perform fine tuning of the cosine similarity estimation unit 133 using the estimation result of LLM similarity obtained by the LLM similarity estimation unit 132.

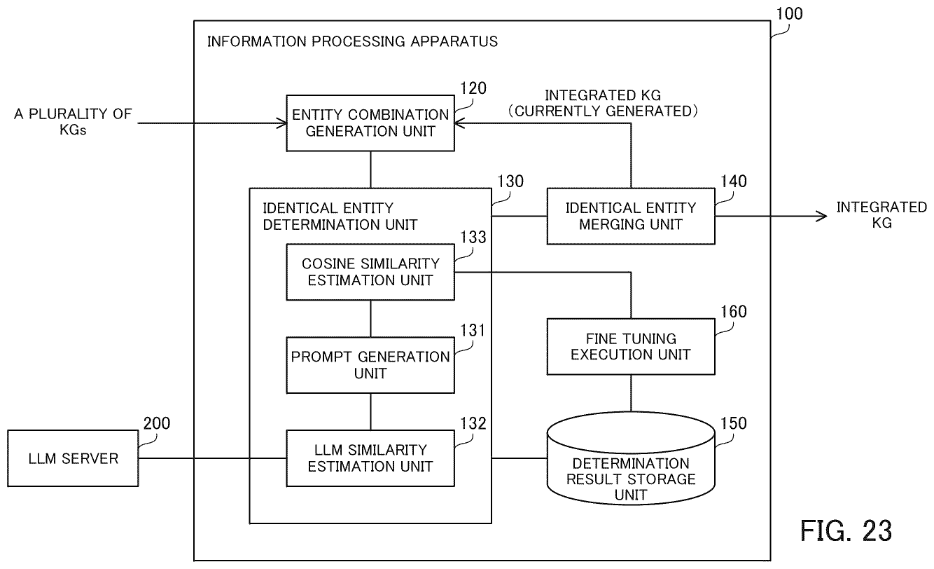

FIG. 23 illustrates an example of functions of an information processing apparatus according to the fifth embodiment.

The information processing apparatus 100 includes the entity combination generation unit 120, the identical entity determination unit 130, the identical entity merging unit 140, a determination result storage unit 150, and a fine tuning execution unit 160. Here, the fifth embodiment is different from the third and fourth embodiments in that the information processing apparatus 100 includes the determination result storage unit 150 and the fine tuning execution unit 160.

The determination result storage unit 150 stores an equivalence determination result for each combination of entities, which is obtained by the identical entity determination unit 130. For example, the determination result storage stores unit 150 a data set including combinations of entities that are semantically equivalent and combinations of entities that are semantically different. The data set may include an LLM similarity estimated for each combination of entities.

The fine tuning execution unit 160 executes fine tuning of a sentence vector conversion model in the cosine similarity estimation unit 133, using the data set stored in the determination result storage unit 150 as teacher data. In the fine tuning, additional training is performed on the sentence vector conversion model using the teacher data, to adjust the parameters used in the sentence vector conversion model.

Thus, the information processing apparatus 100 is able to increase the accuracy of cosine similarity estimation performed by the cosine similarity estimation unit 133. As a result, the information processing apparatus 100 is able to increase the accuracy of filtering combinations of entities based on cosine similarity. Therefore, the information processing apparatus 100 is able to further improve the efficiency of the integrated KG generation process.

### Modifications

Next, modifications of the third to fifth embodiments will be described. The information processing apparatus 100 may set a threshold S_{cos}^{th} for cosine similarity and a threshold S_{LLM}^{th} for LLM similarity as follows.

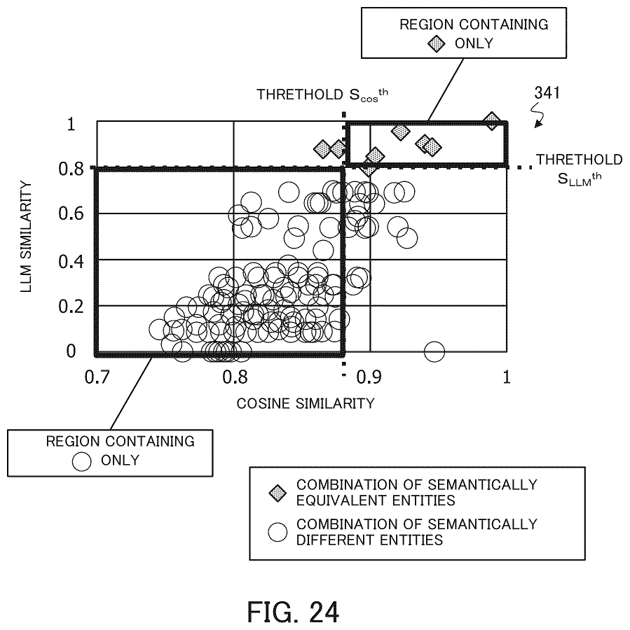

FIG. 24 is a diagram for describing how to set thresholds.

For example, the identical entity determination unit 130 experimentally prepares in advance a data set that includes combinations of entities that are semantically equivalent and combinations of entities that are semantically different, and obtains a cosine similarity and an LLM similarity for each combination, based on the data set. Then, in a graph 341 in which the combinations of entities are plotted based on the obtained cosine similarities and LLM similarities, the identical entity determination unit 130 sets the threshold S_{cos}^{th} and the threshold S_{LLM}^{th} so as to identify a region containing only combinations of entities that are semantically equivalent. In the graph 341, the horizontal axis represents cosine similarity and the vertical axis represents LLM similarity.

The region of the graph 341 is divided into four subregions by straight lines representing the threshold S_{cos}^{th} and the threshold S_{LLM}^{th}. Among these four subregions of the graph 341, the upper-right subregion is where both the cosine similarity and the LLM similarity have relatively large values. Therefore, the identical entity determination unit 130 may set the threshold S_{cos}^{th} and the threshold S_{LLM}^{th} so that the upper-right subregion of the graph 341 becomes a region that contains only combinations of entities that are semantically equivalent.

In generating the data set, the identical entity determination unit 130 may prepare only combinations of entities that are semantically equivalent in advance, and then generate combinations of entities that are semantically different by processing the entities using an LLM or another.

In addition, the identical entity determination unit 130 may generate a data set by identifying combinations of entities that are semantically equivalent and combinations of entities that are semantically different using an LLM that achieves higher accuracy than the LLM provided by the LLM server 200. In this case, the identical entity determination unit 130 may dynamically update the thresholds by regenerating the data set and resetting the threshold S_{cos}^{th} and the threshold S_{LLM}^{th} at predetermined timing. Here, the highly accurate LLM used for generating a data set is able to accurately determine the semantic equivalence of entities, but it may need significantly long processing time. In this case, the setting of the thresholds using the highly accurate LLM is performed in advance, prior to the generation of the integrated KG. By setting the thresholds in advance in this manner, the information processing apparatus 100 is able to more accurately determine combinations of entities that are semantically equivalent.

Next, a specific use case of an integrated KG will be described.

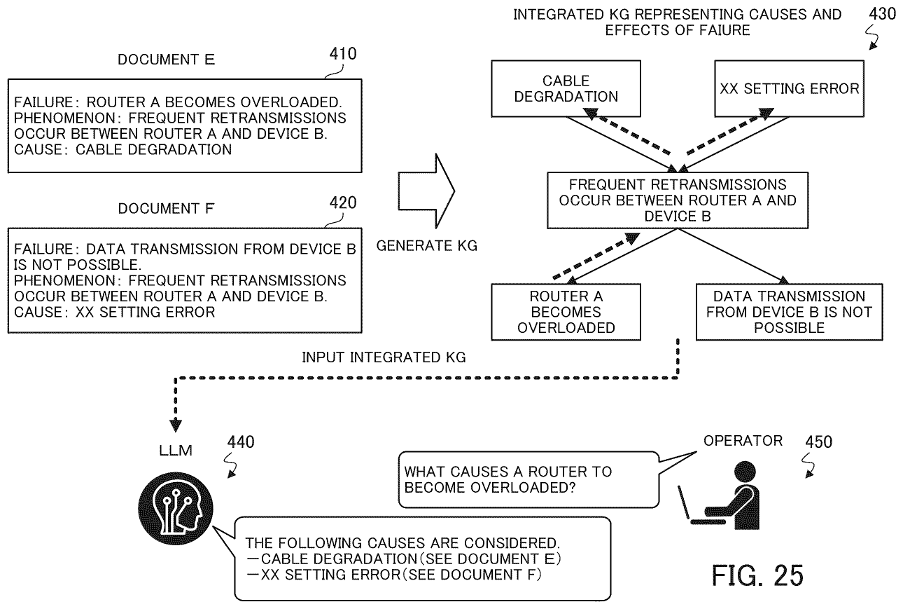

FIG. 25 illustrates a use case of an integrated knowledge graph.

For example, the information processing apparatus 100 generates, for each document that describes a failure event, a KG representing the cause and effect of the failure, and integrates these KGs into a knowledge database, so as to enables highly accurate failure cause analysis. In one example, the information processing apparatus 100 generates a KG from each of documents 410 and 420 that each describe a failure event. The information processing apparatus 100 then integrates the KG corresponding to the document 410 and the KG corresponding to the document 420 to thereby generate an integrated KG 430 representing the causes and effects of the failure. Here, the document 410 is named Document E. The document 420 is named Document F.

Then, the information processing apparatus 100 inputs the integrated KG 430 into an LLM 440, for example, and trains the LLM 440 through machine learning based on the integrated KG 430. As a result, knowledge derived from a comprehensive interpretation of the documents 410 and 420 is reflected in the LLM 440. Note that the LLM 440 may be provided by another information processing apparatus (for example, the LLM server 200 or the like) that is able to communicate with the information processing apparatus 100. The information processing apparatus 100 may include the LLM 440.

An operator 450 is able to obtain answers to natural language questions from the LLM 440 by inputting the questions into the LLM 440 using a terminal device. For example, the operator 450 may input a question “What causes a router to become overloaded?”. In response, the LLM 440 outputs the following answer based on the knowledge obtained by comprehensively interpreting the documents 410 and 420. “The following causes are considered.
Cable degradation (see Document E)
XX setting error (see Document F)”

The answer output by the LLM 440 is displayed on, for example, the display of the terminal device used by the operator 450.

In this way, the information processing apparatus 100 is able to assist the operator 450 in the failure cause analysis, by generating the integrated KG 430. Further, the information processing apparatus 100 is able to contribute to more efficient failure cause analysis by appropriately generating the integrated KG 430.

As described above, the information processing apparatus 100 according to the second to fifth embodiments performs the following processing. The entity combination generation unit 120 acquires, from a first knowledge graph and a second knowledge graph, combinations each containing a first entity included in the first knowledge graph and a second entity included in the second knowledge graph. Each of the first knowledge graph and the second knowledge graph indicates a causal relationship between a plurality of entities. The identical entity determination unit 130 inputs the first entity and the second entity into a machine learning model, which is able to output a similarity between two entities in response to an input of the two entities, and instructs the machine learning model to decrease the similarity between the first entity and the second entity if the relationship between the first entity and the second entity is a predetermined relationship. The identical entity determination unit 130 acquires the similarity between the first entity and the second entity output by the machine learning model. The identical entity determination unit 130 compares the similarity with a threshold, and determines that the first entity and the second entity are semantically equivalent if their similarity is greater than the threshold. The identical entity merging unit 140 generates a third knowledge graph by merging the first knowledge graph and the second knowledge graph, treating the first entity and the second entity as identical entities, i.e., semantically identical entities if their similarity is greater than the threshold.

Accordingly, the information processing apparatus 100 is able to improve the accuracy of similarity estimation between two entities. In addition, the information processing apparatus 100 is able to appropriately generate the third knowledge graph by integrating the first knowledge graph and the second knowledge graph. Note that the LLM provided by the LLM server 200 is an example of the machine learning model. The LLM similarity is an example of the similarity output by the machine learning model.

Here, at least one of the first entity and the second entity is a sentence. The information processing apparatus 100 is particularly useful when sentences are included as entities in knowledge graphs, and is able to increase the accuracy of the similarity between two entities.

For example, the predetermined relationship includes at least one of a cause-effect relationship, a simultaneity relationship, and a subject-predicate relationship. With such relationships, it becomes unlikely to merge a first entity and a second entity into one entity if these first and second entities have a cause-effect relationship, a simultaneity relationship, or a subject-predicate relationship. This enables the information processing apparatus 100 to generate the third knowledge graph that appropriately reflects information contained in the first knowledge graph and the second knowledge graph.

Further, an instruction to the machine learning model may include, for example, at least one of the following: an instruction to determine similarity through consensus decision-making, an example of a predetermined relationship, and an example answer indicating a similarity between two example sentences.

Accordingly, the information processing apparatus 100 is able to further improve the accuracy of similarity estimation between the first entity and the second entity. Note that the above-described prompt 131b based on ToT is an example of an instruction to determine similarity through consensus decision-making by a plurality of virtual respondents (for example, experts). The prompt 131c based on ICL is an example of an instruction that includes an example of a predetermined relationship. In addition, the prompt 131d based on ICL is an example of an instruction that includes an example answer indicating a similarity between two example sentences (e.g., sentences of “event 1” and “event 2”). The instruction to the machine learning model may also include a definition of the similarity.

In addition, the identical entity determination unit 130 may select, based on the cosine similarity between the first entity and the second entity, combinations of entities for which their similarity is to be acquired by the machine learning model. As a result, the information processing apparatus 100 is able to acquire the similarities by the machine learning model at high speed and with high accuracy.

In addition, in the generation of the third knowledge graph, the identical entity merging unit 140 may acquire a plurality of combinations each containing the first entity and the second entity acquired from the first knowledge graph and the second knowledge graph, in which each combination has a similarity greater than a threshold. The identical entity merging unit 140 may select, for each first entity, a combination having the maximum similarity from the plurality of combinations. The identical entity merging unit 140 may then select, for each second entity, a combination having the maximum similarity from the combinations selected for the first entities. The identical entity merging unit 140 may then determine that the first entity and the second entity belonging to each of the combinations selected for the second entities are identical entities.

Accordingly, the information processing apparatus 100 is able to efficiently select pairs of entities to be treated as identical entities. In addition, the information processing apparatus 100 is able to appropriately reflect information contained in the first knowledge graph and the second knowledge graph, in the third knowledge graph.

In addition, with respect to a plurality of combinations each containing a first entity and a second entity, acquired from the first knowledge graph and the second knowledge graph, the identical entity determination unit 130 may acquire, for each combination, a determination result regarding the semantic equivalence of the first entity and the second entity belonging to that combination, on the basis of a comparison between the similarity obtained for the combination and a threshold. This determination result of the semantic equivalence may be considered to be a result of determining whether the first entity and the second entity are semantically equivalent. The determination result of the semantic equivalence may include a similarity between the first entity and the second entity output by a machine learning model such as an LLM. The fine tuning execution unit 160 may use this determination result to fine-tune the language model used to calculate cosine similarity.

Accordingly, the information processing apparatus 100 is able to improve the accuracy of the cosine similarity and increase the accuracy of filtering the combinations of the first entity and the second entity. The sentence vector conversion model 90 is an example of a language model used to calculate cosine similarity.

In addition, the entity combination generation unit 120 acquires, from the third knowledge graph and a fourth knowledge graph, combinations of a third entity included in the third knowledge graph and a fourth entity included in the fourth knowledge graph. The identical entity determination unit 130 obtains the similarity between the third entity and the fourth entity using the machine learning model. The identical entity merging unit 140 generates a fifth knowledge graph by merging the third knowledge graph and the fourth knowledge graph, treating the third entity and the fourth entity as identical entities if their similarity is greater than a threshold.

In this way, the information processing apparatus 100 is able to sequentially integrate a plurality of knowledge graphs to thereby appropriately generate an integrated knowledge graph.

The information processing of the first embodiment may be implemented by causing the processing unit 12 to execute a program. The information processing of the second embodiment may be implemented by causing the processor 101 to execute a program. The program may be recorded on the computer-readable recording medium 113.

For example, the program may be distributed by distributing the recording medium 113 on which the program is recorded. Alternatively, the program may be stored in another computer and distributed via a network. For example, a computer may store (install) the program recorded on the recording medium 113 or the program received from another computer into a storage device such as the RAM 102 or the HDD 103, read the program from the storage device, and execute the program.

In one aspect, it is possible to improve the accuracy of similarity estimation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A generation method comprising:
acquiring, by a processor, from a first knowledge graph and a second knowledge graph, a combination of a first entity included in the first knowledge graph and a second entity included in the second knowledge graph, each of the first knowledge graph and the second knowledge graph representing a causal relationship between a plurality of entities;
inputting, by the processor, the first entity and the second entity to a machine learning model and instructing the machine learning model to decrease a similarity between the first entity and the second entity upon determining that a relationship between the first entity and the second entity is a predetermined relationship, the machine learning model being capable of outputting a similarity between two entities in response to an input of the two entities;
acquiring, by the processor, the similarity between the first entity and the second entity, the similarity being output by the machine learning model; and
generating, by the processor, a third knowledge graph by merging the first knowledge graph and the second knowledge graph, treating the first entity and the second entity whose similarity is greater than a threshold as identical entities.

2. The generation method according to claim 1, wherein the predetermined relationship includes at least one of a cause-effect relationship, a simultaneity relationship, or a subject-predicate relationship.

3. The generation method according to claim 1, wherein the instructing to the machine learning model includes at least one of an instruction to determine the similarity between the first entity and the second entity through consensus decision-making, an example of the predetermined relationship, or an example answer indicating a similarity between two example sentences.

4. The generation method according to claim 1, further comprising:
selecting, by the processor, based on a cosine similarity between the first entity and the second entity, a target combination for which a similarity is to be acquired by the machine learning model.

5. The generation method according to claim 1, wherein the generating of the third knowledge graph includes:
acquiring, by the processor, from the first knowledge graph and the second knowledge graph, a plurality of combinations each containing the first entity and the second entity, the plurality of combinations each having a similarity greater than the threshold;
selecting, by the processor, for each of first entities, a combination having a maximum similarity from the plurality of combinations;
selecting, by the processor, for each of second entities, a combination having a maximum similarity from combinations selected for said each of the first entities; and
determining, by the processor, that the first entity and the second entity belonging to the combination selected for said each of the second entities are identical entities.

6. The generation method according to claim 4, further comprising:
acquiring, by the processor, for each combination of a plurality of combinations each containing the first entity and the second entity, the plurality of combinations being acquired from the first knowledge graph and the second knowledge graph, a determination result of determining semantic equivalence between the first entity and the second entity belonging to said each combination, based on a comparison between the similarity corresponding to said each combination and the threshold; and
performing, by the processor, fine tuning of a language model using the determination result, the language model being used to calculate the cosine similarity.

7. The generation method according to claim 1, further comprising:
acquiring, by the processor, from the third knowledge graph and a fourth knowledge graph, a combination of a third entity included in the third knowledge graph and a fourth entity included in the fourth knowledge graph;
acquiring, by the processor, a similarity between the third entity and the fourth entity using the machine learning model; and
generating, by the processor, a fifth knowledge graph by merging the third knowledge graph and the fourth knowledge graph, treating the third entity and the fourth entity whose similarity i s greater than the threshold as identical entities.

8. The generation method according to claim 1, wherein at least one of the first entity or the second entity is a sentence.

9. A non-transitory computer-readable storage medium storing a computer program that causes a computer to perform a process comprising:
acquiring, from a first knowledge graph and a second knowledge graph, a combination of a first entity included in the first knowledge graph and a second entity included in the second knowledge graph, each of the first knowledge graph and the second knowledge graph representing a causal relationship between a plurality of entities;
inputting the first entity and the second entity to a machine learning model and instructing the machine learning model to decrease a similarity between the first entity and the second entity upon determining that a relationship between the first entity and the second entity is a predetermined relationship, the machine learning model being capable of outputting a similarity between two entities in response to an input of the two entities;
acquiring the similarity between the first entity and the second entity, the similarity being output by the machine learning model; and
generating a third knowledge graph by merging the first knowledge graph and the second knowledge graph, treating the first entity and the second entity whose similarity is greater than a threshold as identical entities.

10. An information processing apparatus comprising:
a memory configured to store information on a first knowledge graph and a second knowledge graph, each of the first knowledge graph and the second knowledge graph representing a causal relationship between a plurality of entities; and
a processor coupled to the memory and the processor configured to:
acquire a combination of a first entity included in the first knowledge graph and a second entity included in the second knowledge graph;
input the first entity and the second entity to a machine learning model and instruct the machine learning model to decrease a similarity between the first entity and the second entity upon determining that a relationship between the first entity and the second entity is a predetermined relationship, the machine learning model being capable of outputting a similarity between two entities in response to an input of the two entities;
acquire the similarity between the first entity and the second entity, the similarity being output by the machine learning model; and
generate a third knowledge graph by merging the first knowledge graph and the second knowledge graph, treating the first entity and the second entity whose similarity is greater than a threshold as identical entities.
